(19) United States
(12) Patent Application Publication
(10) Pub. No.: US 2015/0343323 A1
(43) Pub. Date: Dec. 3, 2015

(54) SPINABLE FAN WITH INTERCHANGEABLE BLADES

(71) Applicant: MAXIMUM VISIBILITY SOLUTIONS, LLC, DULUTH, GA (US)

(72) Inventor: PAUL E. SIDWELL, DULUTH, GA (US)

(73) Assignee: MAXIMUM VISIBILITY SOLUTIONS, LLC, DULUTH, GA (US)

(21) Appl. No.: 14/290,181

(22) Filed: May 29, 2014

(51) Int. Cl. A63H 33/40; F03D 3/06; F03D 11/00; F03D 3/00

(52) U.S. Cl. CPC A63H 33/40; F03D 3/005; F03D 3/064; F03D 11/0008

(57) ABSTRACT

A fan assembly can be used under different indoor and outdoor environmental conditions. One or more blades can be attached to an upper bearing assembly and a lower bearing assembly around a central stem. The shape and configuration of the blades can further impart the fan assembly with a 3-dimensional appearance that responds to wind or other air flow, causing a spinning effect. The rigidity of the central stem, as well as components of the blade ensure that the fan assembly maintains the 3-dimensional shape even under high wind or air flow conditions.

### BACKGROUND OF THE INVENTION

The use of inflatable decorative or merchandising products in an outdoor environment is often hampered by environmental conditions that adversely affect the appearance of such objects. Wind and rain can cause objects to become distorted in shape. Also, varying atmospheric and temperature conditions may cause the inflated devise to either appear to have lost air, due to colder weather causing the air density/volume to change. Or the possibility of over inflating due to expansion of air during extremely hot temperatures conditions, whereby leaking or tearing may occur. Other problems associated with using inflatable products for advertising or artistic display, are set up, break down, storage, shipping and lifetime of reusability.

A device that appears physically as an inflatable object, but does not need to be inflated by pressurized air/gas, or other sources, such as an electric fan or compressor, that maintains its shape and orientation under all weather conditions, that is light weight, able to fold flat for storage and shipping and is also reusable, would be an advantageous improvement. Such devices that have an improved appearance due to outdoor conditions, such as wind, would be particularly efficacious for long-term placement.

### BRIEF SUMMARY

In accordance with the embodiments of the subject invention, the problem of displaying a decorative object in an upright position during adverse conditions is solved by use of a fan assembly with reinforced blades attached to a rigid central stem, where the blades can spin relative to the central stem. The assembled fan can be adapted to a variety of 3-dimensional shapes, depending upon the configuration of the fan blades. In a specific embodiment, the fan is configured to resemble the shape and vertical orientation of a typical teardrop shaped inflatable balloon. The rigidity of the assembly and the ability of the blades to spin minimizes the effect of environmental conditions, such as wind and rain, allowing the fan assembly to maintain a generally upright position to maximize the display value. The blades of the fan can be interchangeable, so that various blade options can be grouped and arranged to show a 3-dimensional shape to maximum advantage.

The subject invention pertains to a device of semi-rigid and/or reinforced blades attached around a vertical central stem. Typically, the blades are arranged around the central stem and can at least partially overlap. The blades are further attached at each end to unique bearing assemblies located on the central stem that allow the blades to spin in circular fashion around the central stem, so as to provide a 3-dimensionally shaped object that can react to air currents. The judicious selection of materials for the fan assembly can further inhibit adverse effects of rain, fog, or other moisture conditions. The rigidity of the central stem in conjunction with the rigidity of and/or reinforced blades can aid in maintaining the shape and orientation of the device, which is particularly advantageous when used outdoors to maximize the display value of the fan.

A further advantage of the devices of the subject invention is the ability to fold the blades against each other, so that they form a flattened shape. This makes shipping and storing the device easier and more efficient.

It should be noted that this Brief Summary is provided to generally introduce the reader to one or more select concepts described below in the Detailed Disclosure in a simplified form. This Summary is not intended to identify key and/or required features of the claimed subject matter. Other aspects and further scope of applicability of the present invention will also become apparent from the detailed descriptions given herein. It should be understood, however, that the detailed descriptions, while indicating preferred embodiments of the invention, are given by way of illustration only, since various changes and modifications within the spirit and scope of the invention will become apparent from such descriptions. The invention is defined by the claims below.

### BRIEF DESCRIPTION OF DRAWINGS

In order that a more precise understanding of the above recited invention can be obtained, a more particular description of the invention briefly described above will be rendered by reference to specific embodiments thereof that are illustrated in the appended drawings. The drawings presented herein may not be drawn to scale and any reference to dimensions in the drawings or the following description is specific to the embodiments disclosed. Any variations of these dimensions that will allow the subject invention to function for its intended purpose are considered to be within the scope of the subject invention. Thus, understanding that these drawings depict only typical embodiments of the invention and are not therefore to be considered as limiting in scope, the invention will be described and explained with additional specificity and detail through the use of the accompanying drawings in which:

FIG. 1A shows an exemplary embodiment of the device of the subject invention.

FIG. 1B shows a top end view of the embodiment in FIG. 1A.

FIGS. 1C, 1D, 1E, 1F, 1G, and 1H illustrate embodiments of fan assemblies of the subject invention having 8, 10, and 12 blade configurations.

FIGS. 2A and 2B illustrate one embodiment of a central stem of the fan assembly.

FIGS. 2C and 2D illustrate an embodiment of an assembled central stem, where FIG. 2C is a front elevation view and FIG. 2D is a top plan view.

FIGS. 3A, 3B, and 3C illustrate one embodiment of an internal shaft. FIG. 3B is a cross-section of FIG. 3A. FIG. 3C is a proximal end view of FIG. 3A.

FIGS. 3D, 3E, and 3F illustrate an alternative embodiment of an internal shaft. FIG. 3E is a cross-section of FIG. 3D. FIG. 3F is a proximal end view of FIG. 3D.

FIGS. 4A, 4B, 4C, 4D, and 4E illustrate one embodiment of an external slide sleeve.

FIG. 4A is a front elevation view; FIG. 4B is a side elevation view; FIG. 4C is a cross-sectional view; FIG. 4D is a distal plan view; and FIG. 4E is a proximal plan view.

FIGS. 5A, 5B, 5C, and 5D illustrate one embodiment of a lower slide sleeve. FIG. 5A is a front elevation view. FIG. 5B is a cross-section of FIG. 5A. FIG. 5C is a proximal end plan view and FIG. 5D is a distal end plan view.

FIGS. 5E, 5F, 5G, and 5H illustrate an alternative embodiment of a lower slide sleeve. FIG. 5E is a front elevation view. FIG. 5F is a cross-section of FIG. 5E. FIG. 5G is a proximal end plan view and FIG. 5H is a distal end plan view.

FIGS. 6A, 6B, 6C, and 6D illustrate one embodiment of a top hub. FIG. 6A is a front elevation view; FIG. 6B is a bottom plan view; FIG. 6C is a cross-sectional view of FIG. 6A; and FIG. 6D is a top plan view.

FIG. 6E is a perspective view of an embodiment of a top hub.

FIGS. 7A, 7B, 7C, and 7D illustrate one embodiment of an upper bearing cap. FIG. 7A is a front elevation view; FIG. 7B is a bottom plan view; FIG. 7C is a cross-section view; and FIG. 7D is a top plan view.

FIG. 7E is a perspective view of one embodiment of an upper bearing cap.

FIGS. 8A, 8B, 8C, and 8D illustrate one embodiment of a slotted base. FIG. 8A is a front elevation view; FIG. 8B is a top plan view; FIG. 8C is a cross-section view; and FIG. 8D is a bottom plan view.

FIG. 8E illustrates a cross-sectional view of an embodiment of a cap fitted to a slotted base for an upper bearing assembly. For clarity, the twist ball joints and bearing are not shown in this view.

FIG. 8F is perspective view of an embodiment of a slotted base.

FIGS. 9A, 9B, 9C, and 9D illustrate one embodiment of a twist ball joint. FIG. 9A is a front elevation view; FIG. 9B is a cross-section view; FIG. 9C is a side elevation view; and FIG. 9D is a proximal end view.

FIGS. 10A, 10B, 10C, and 10D illustrate one embodiment of a base. FIG. 10A is a front elevation view; FIG. 10B is a top plane view; FIG. 10C is a cross-sectional view; and FIG. 10D is a bottom plan view.

FIGS. 11A, 11B, 11C, and 11D illustrate one embodiment of a slotted cap. FIG. 11A is a front elevation view; FIG. 11B is a distal plan view; FIG. 11C is a cross-sectional view; and FIG. 11D is a proximal plan view.

FIG. 11E is a cross-sectional view of an embodiment of a slotted cap fitted to a base in a lower bearing assembly. For clarity, the ball joints and bearing are not shown in this view.

FIGS. 12A, 12B, and 12C illustrate one embodiment of a ball joint that can be utilized with a lower bearing assembly, according to the subject invention.

FIGS. 13A-131 illustrate embodiments of securing mechanism in the form of clips that can be utilized with embodiments of the subject invention. FIGS. 13A and 13D are top plan views of clip embodiments; FIGS. 13B and 13E are front elevation views thereof; and FIGS. 13C and 13F are side elevation views thereof.

FIGS. 14A and 14B illustrate one embodiment of a blade assembly and different embodiments of a spine. FIG. 14C illustrates one embodiment of a spine having a tippet at the proximal tip and distal tip.

FIGS. 15A and 15B illustrate an alternative embodiment of a twist ball joint (15A) and a ball joint (15B), wherein the arms are externally threaded and have a side slit.

FIGS. 16A and 16B illustrate an embodiment of an end connector that can operably connect to the alternative embodiments of a twist ball joint and ball joint shown in FIGS. 15A and 15B to secure the spine ends to the ball joints.

FIG. 17 is a perspective view of a spine tippet that can assist in holding the spine ends of a blade into the alternative embodiments of the ball joints, shown in FIGS. 15A and 15B.

FIGS. 18A, 18B, 18C, and 18D illustrate one embodiment of an alignment fin.

FIGS. 19A-19F illustrate examples of multiple alignment fins attached to an upper bearing cap of the subject invention.

### DETAILED DISCLOSURE

The subject invention pertains to a fan assembly that can spin circularly around a rigid central stem. More specifically, the subject invention provides one or more embodiments of a fan assembly with replaceable blades that when spinning provide a 3-dimensional visual effect. The embodiments described herein include structures that can be assembled and disassembled to allow for replacement of individual fan blades for repair or customization. In a particularly advantageous embodiment, the device can be flattened, with the blades attached, to provide a substantially flattened configuration. In one embodiment, the components of the shaft assembly can be pressed or compressed together to shorten the length of the shaft assembly. This can cause the surrounding blades to bend or curve, while at the same time overlapping with each other, to form a fully 3-dimensional object.

The following description will disclose that the subject invention is particularly useful for, but is not limited to, placement outdoors, in particular, areas where weather conditions can affect the shape and position of regular inflatable balloons. However, a person with skill in the art will be able to recognize numerous other uses that would be applicable to the devices and methods of the subject invention. While the subject application describes, and many of the terms herein relate to, outdoor placement or areas where normal inflatable balloons and the like are adversely affected, other modifications apparent to a person with skill in the art and having benefit of the subject disclosure are contemplated to be within the scope of the present invention.

As used herein, and unless otherwise specifically stated, the terms “operable communication,” “operable connection,” “operably connected,” “cooperatively engaged” and grammatical variations thereof mean that the particular elements are connected in such a way that they cooperate to achieve their intended function or functions. The “connection” or “engagement” may be direct, or indirect, physical or remote.

Further, reference is made throughout the application to the “proximal end 5” and “distal end 15.” As used herein, the proximal end is that end located closest to an object or surface by which the fan can be supported or connected. Conversely, the distal end of the device is that end furthest from the surface when the fan is substantially vertically aligned, or perpendicular to the surface.

The present invention is more particularly described in the following examples that are intended to be illustrative only since numerous modifications and variations therein will be apparent to those skilled in the art. As used in the specification and in the claims, the singular for “a,” “an” and “the” include plural referents unless the context clearly dictates otherwise.

Reference will be made to the attached figures on which the same reference numerals are used throughout to indicate the same or similar components. With reference to the attached figures, which show certain embodiments of the subject invention, it can be seen that a fan assembly 10 of the subject invention comprises a central stem 20 having a shaft assembly 100 to which is attached an upper bearing assembly 200 and a lower bearing assembly 300. Attached to the shaft assembly are at least one, ideally a plurality, of blade assemblies 500. The details of each of the components will be discussed below.

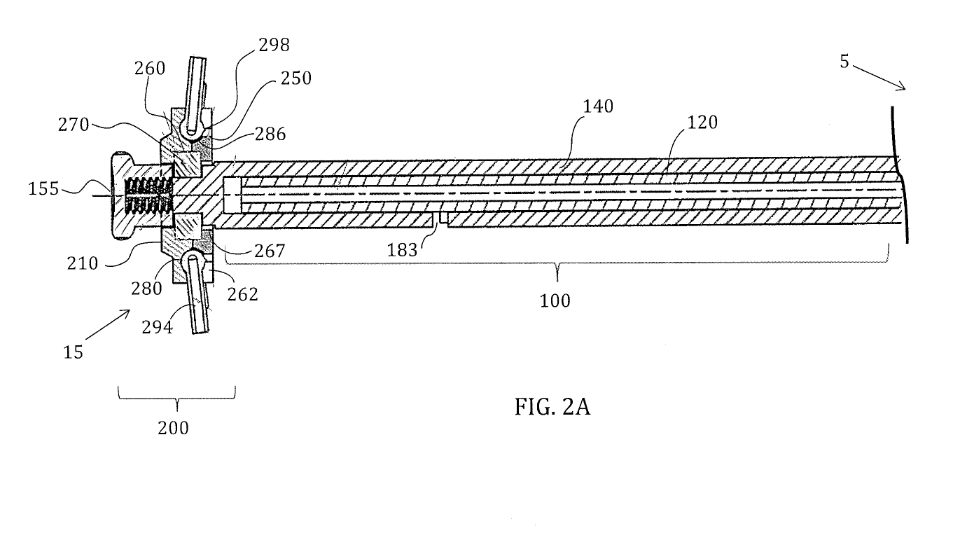

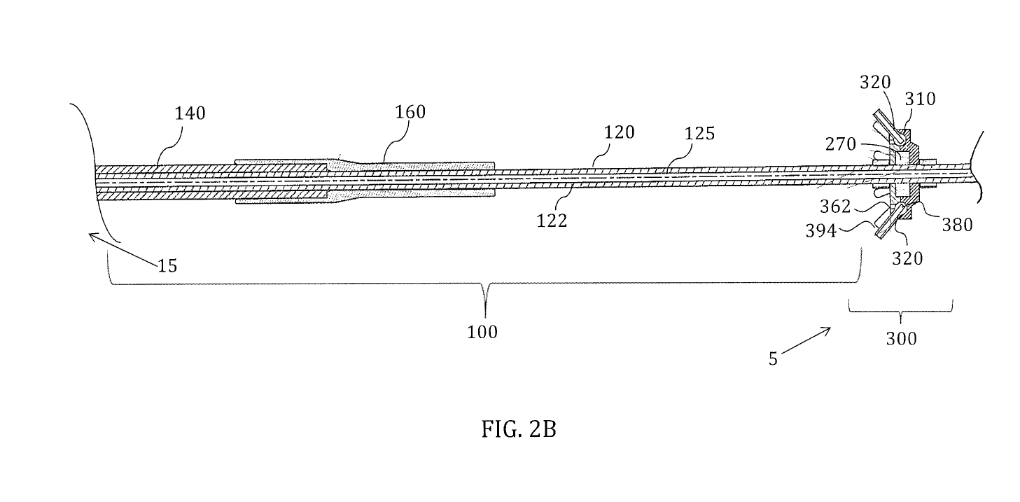

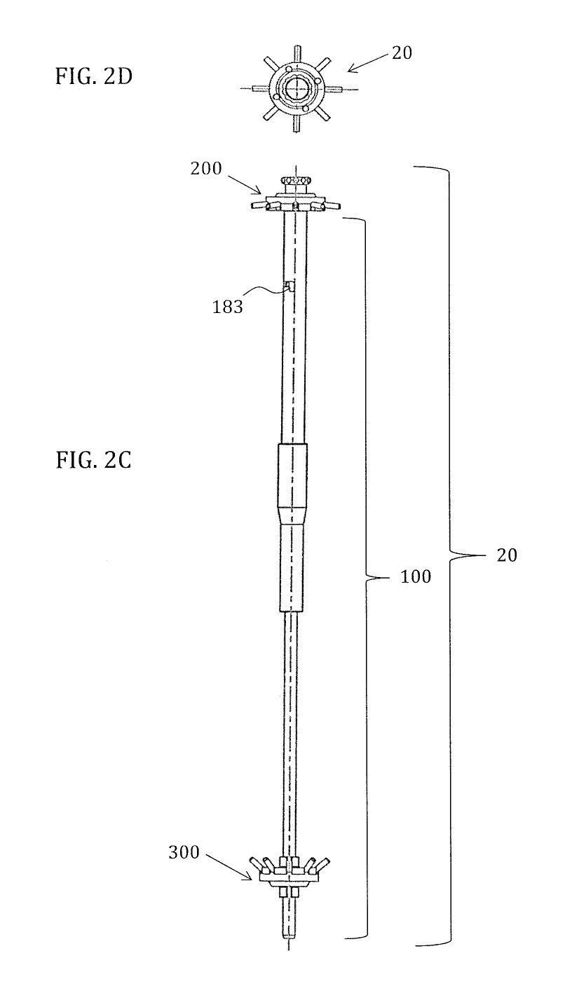

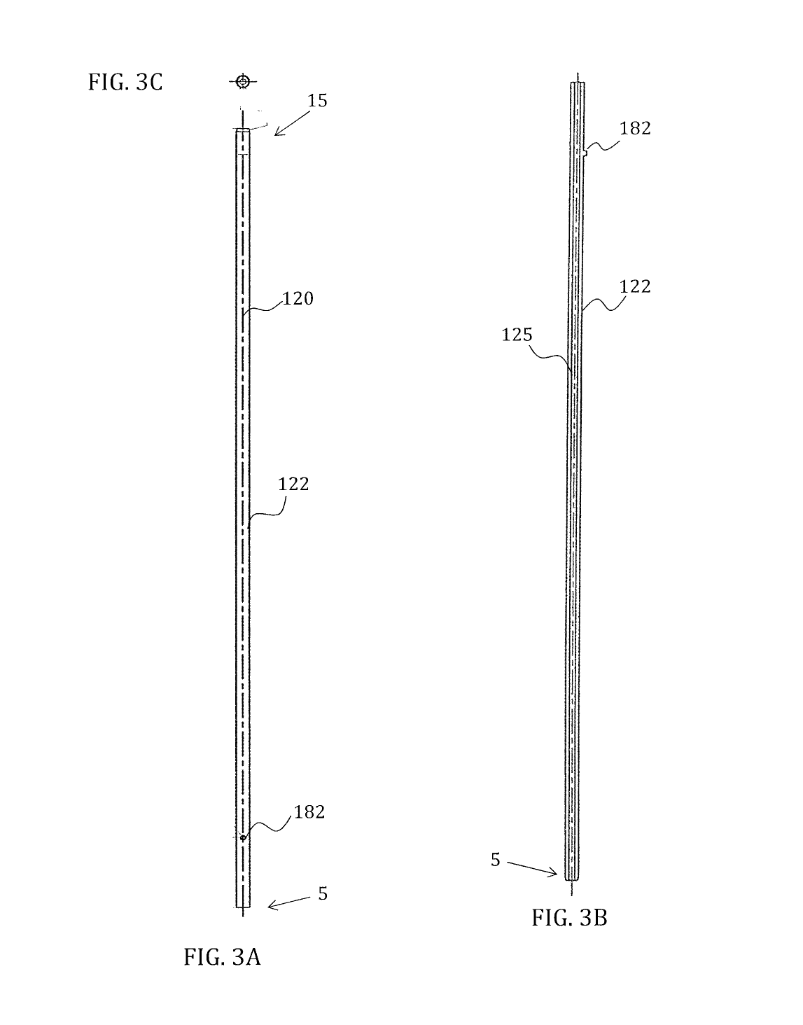

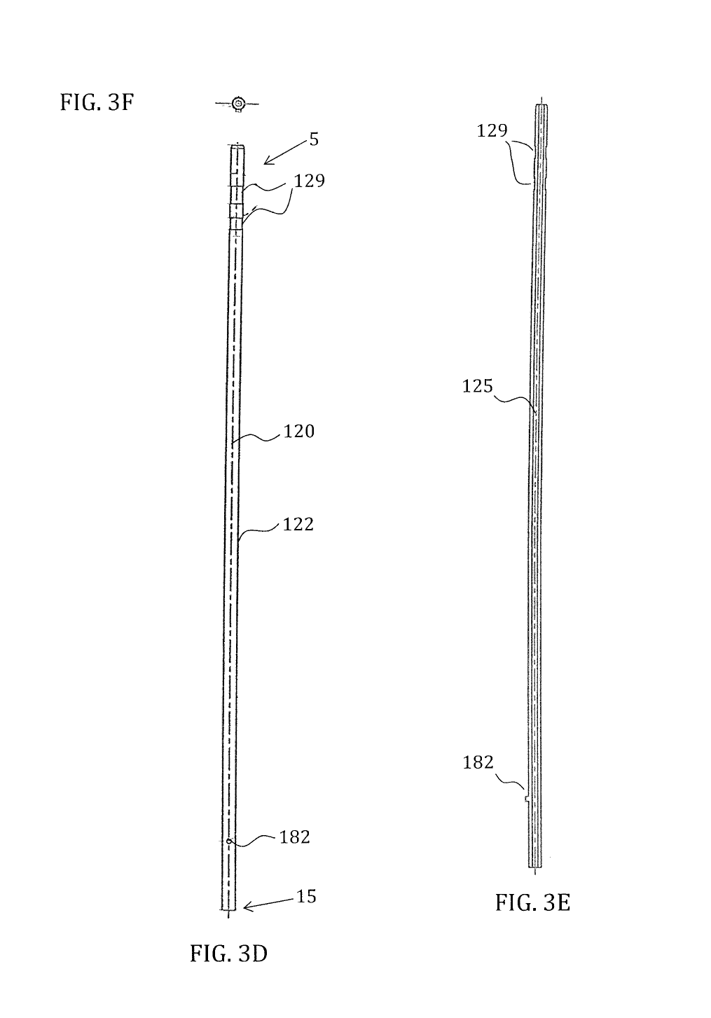

With reference to FIGS. 2A and 2B, the shaft assembly 100 can include an internal shaft 120, an external slide sleeve 140, and a lower slide sleeve 160. As seen in FIGS. 2A, 2B, and 2C, the internal shaft 120 can provide support for the entire fan assembly 10. In one embodiment, the internal shaft is an elongate body. In a further embodiment, the internal shaft has a substantially smooth exterior surface 122, an example of which is shown in FIGS. 3A-3E. The internal shaft can be solid or, in an alternative embodiment, it can have a central bore 125, which can open onto the proximal end 5. The proximal end 5 of the internal shaft can be attached, coupled, affixed, or otherwise operably engaged with a surface or object by means of any device or method known in the art that will support the fan assembly in the desired position. Embodiments having a central bore 125 can be operably engaged by insertion of an object or device into the central bore to support the fan assembly. In a specific embodiment, the length of the internal shaft from the proximal to distal ends is between approximately 18.00 inches and approximately 19.00 inches. In another specific embodiment, the depth of the central bore is between approximately 17.00 inches and approximately 18.00 inches. In yet another specific embodiment, the diameter of an internal shaft is between approximately 0.30 inches and 0.32 inches.

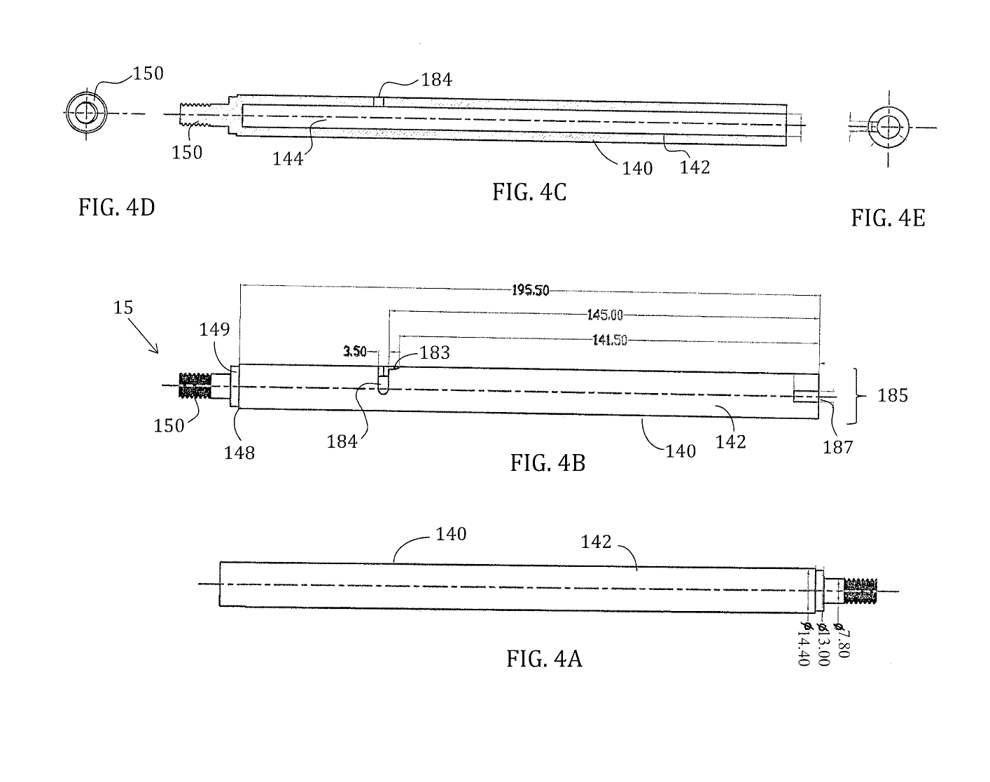

As will be discussed below, the internal shaft can be operably connected to an external slide sleeve 140, one embodiment of which is shown in FIGS. 4A-4D. In one embodiment, the distal end 15 of the internal shaft is disposed within a channel 144 of the external slide sleeve. The internal shaft 120 can slide, turn, or otherwise move within the channel. Alternatively, the internal shaft can be adapted to be stationary within the channel. This can be achieved by having the surface 122 of the internal shaft and channel 144 of the external slide sleeve engaged by a friction fit, such that the internal shaft will not move relative to the external slide sleeve when engaged. A friction fit can allow the internal shaft to be disengaged from the external slide sleeve. Alternatively, the internal shaft and external slide sleeve can be permanently engaged by a friction fit or other means known to those with skill in the art.

The internal shaft and external slide sleeve can also be configured with one or more attachment mechanisms 180. In one embodiment, shown in FIGS. 3A, 3D, and 4B, the internal shaft and external slide sleeve can be engaged by a slide lock-type of attachment mechanism. With this embodiment, one component can have a lock 182 and another component can have a track 184 in which the lock can be engaged and secured. In one embodiment of the subject invention, the internal shaft has a lock 182 in the form of a protruding tab on the exterior surface 122. When the internal shaft is engaged with the external sliding shaft, the lock 182 can slide within the channel 144. The external slide sleeve can have a track 184 in the form of a transverse cut contiguous within the channel 144, an example of which is shown in FIG. 4B. The lock can slide through the channel and be operably engaged with the track 184 transverse cut to inhibit movement of the internal shaft 120 in the external slide sleeve 140. In a particular embodiment, the lock is located at or about the distal end 15 of the internal shaft. In another embodiment, the internal shaft can be pushed, pulled, twisted, rotated, or otherwise manipulated so as to be secured within a portion of the track 184. In a further embodiment, the track can include a drop slot 183, as part of the track and located at one end of the track. A drop slot can be generally perpendicular to the track and extend towards the proximal end of the external slide sleeve, as shown, for example, in FIGS. 2A, 2C, and 4B.

As will be explained in more detail below, the blades, when attached to the hubs can provide a spring-action effect that provides a biasing force between the hubs, causing the internal shaft and the external slide sleeve to slide apart, whereby the external slide sleeve is biased towards the distal end of the internal shaft. Thus, when force is exerted against the distal end of the external slide sleeve and/or the proximal end of the internal shaft, the external slide sleeve can advance proximally over the internal shaft until the lock engages with the track. At this point, the external slide sleeve and internal shaft can be twisted relative to each other, causing the lock to align with the drop slot 183. When the force is released the blades cause the external slide shaft and internal shaft to begin to separate, at which point the lock engaged with the drop slot and prevents the internal shaft and external slide sleeve from sliding any further than the length of the drop slot. This can maintain the blades in a bent or curved position and maintain the 3-dimensional shape of the blades. There are numerous alternative lock and attachment mechanisms that can perform the same function, in substantially the same way, with substantially the same result. Such alternatives are within the scope of this invention.

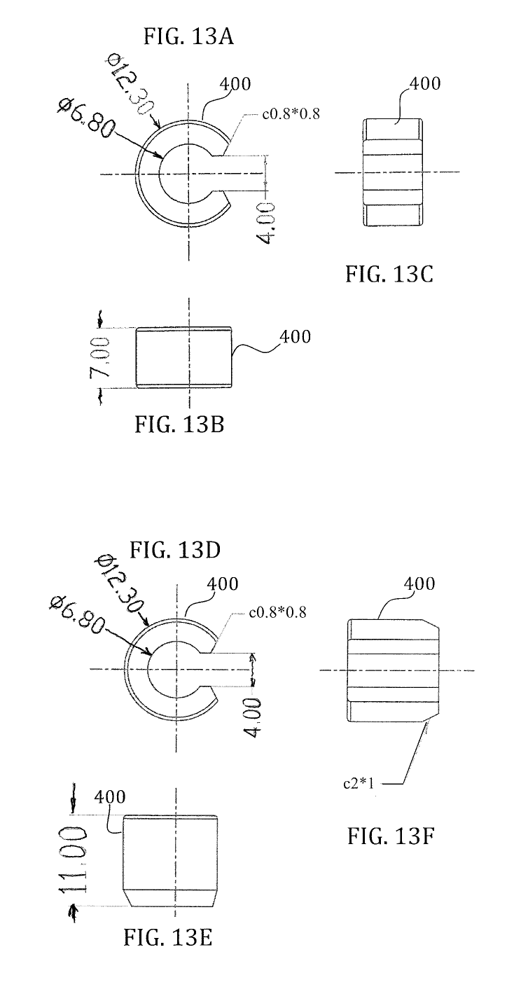

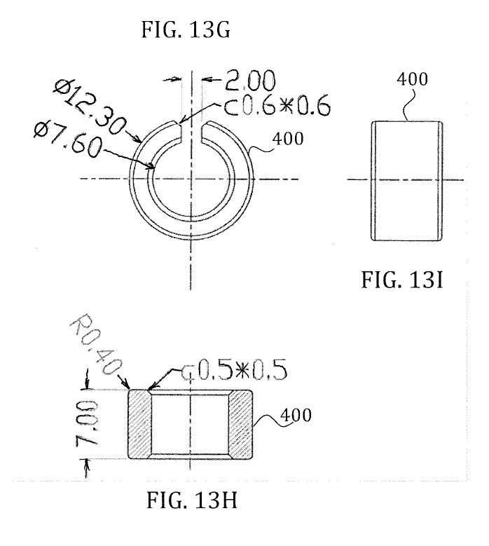

As will be discussed further below, the lower bearing assembly 300 can be engaged around the internal shaft. One or more securing mechanisms 400 can be attached to the internal shaft. A securing mechanism can be any device or method that inhibits movement of the lower bearing assembly relative to the internal shaft. This can include, but is not limited to, cotter pins, immovable sleeves, clamps, or any other similarly-effective devices known to those with skill in the art. In one embodiment, a securing mechanism is a clip that forms a frictions fit around the exterior surface 122 of the internal shaft. FIGS. 13A-13F illustrate embodiments of clips that can be utilized with the subject invention. When positioned in close proximity to the lower bearing assembly, one or more clips can inhibit motion of the lower bearing assembly in a proximal and/or distal direction. In an alternative embodiment, the exterior surface 122 of the internal shaft, at or about where the lower bearing assembly is engaged, has thereon one or more coupling features 129 that aid in securing a clip. In one embodiment, a coupling feature is one or more indentations 129 formed into the internal shaft into which a clip can be disposed, an example of which is shown in FIGS. 3D-3E. In another embodiment, a coupling feature is one or more raised areas, such as, for example, ribs, nibs, bevels, spurs, etc., located on the external surface 122 where the clips can be engaged therewith.

At the distal end 15 of the central stem 20 there can be an upper bearing assembly that, in conjunction with a lower bearing assembly, allows the fan to spin. To facilitate attachment of the upper bearing assembly, an external slide sleeve 140, mentioned briefly above, can be attached to the distal end of the internal shaft. FIGS. 2A, 2C, and 4A-4E illustrate examples of an external slide sleeve that can be used with the embodiments of the subject invention. A slide sleeve can have a body 142 in which the channel 144 is located and opens at the proximal end to engage with the internal shaft. At the distal end 15 of the body there can be a first annular shoulder 148, a second annular shoulder 149, and a terminal end 150 that can be operably attached to a top hub 155.

The distal end of the internal shaft 120 can be disposed in the channel 144. As mentioned above, there can be a slide lock mechanism 126 that engages the internal shaft with the slide sleeve, to inhibit movement therebetween. FIGS. 4A-4C illustrate one embodiment of the annular shoulders 148 and 149 at the distal end of the slide sleeve. Components of the upper bearing assembly can be supported by the shoulders. In one embodiment, there are two annular shoulders. Alternatively, there can be one annular shoulder and the components of an upper bearing assembly can be configured so as to be supported by the single annular shoulder. In a specific embodiment, the length of the body 142 of an external slide sleeve, from the distal to the proximal end, is between approximately 7.5 inches and approximately 8.0 inches. It would also be within the skill of a person trained in the art to determine the diameters of the one or more annular shoulders, depending upon the dimensions of the components of an upper bearing assembly 200.

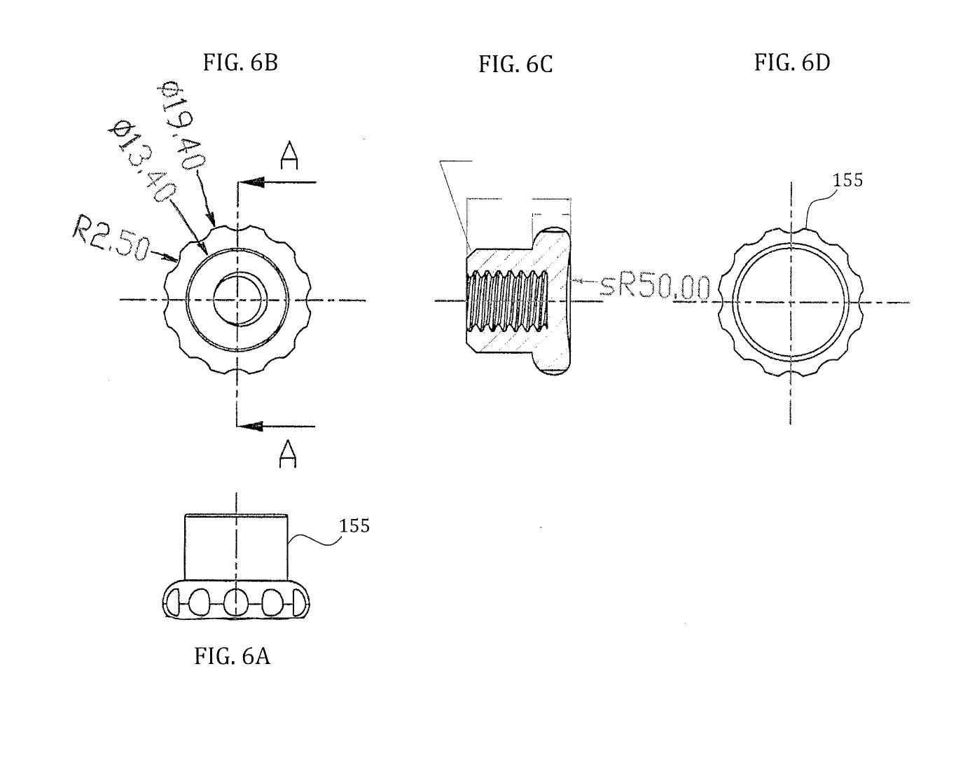

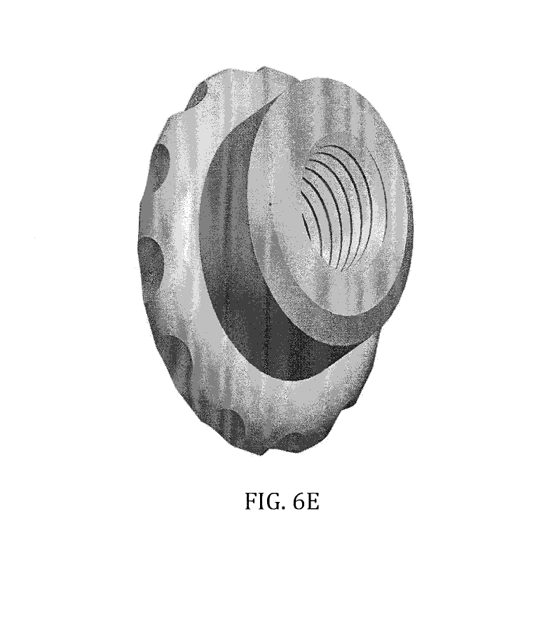

The terminal end 150 of a slide sleeve can be adapted to attach to a top hub 155. When assembled, the top hub 155 maintains the components of the entire fan assembly in their proper configuration. As seen in FIG. 2A, when the top hub is emplaced over the terminal end, it maintains the position of the upper bearing assembly against the slide sleeve, which in turn maintains tension on the blades located between the upper bearing assembly and the lower bearing assembly. Thus, the attachment of the top hub to the terminal end will, ideally, be such that it can be secure. It can also be helpful if the top hub is removable and/or replaceable and/or comprises ergonomic features that make it easy to manipulate. In one embodiment, the top hub is a securing mechanism 400, such as described above. In an alternative embodiment, the top hub is a continuously threaded cap that operatively engages with continuous threading on the terminal end. FIGS. 6A-D illustrate one example of a continuously threaded top hub. Alternatively, the threading in the top hub and on the terminal end can be discontinuous, but operatively connectable. There are numerous methods and devices and top hub configurations known in the art that can be used to secure an upper bearing assembly. Such variations that provide the same function, in substantially the same way, with substantially the same result are within the scope of this invention.

The slide sleeve 140 and internal shaft 120, when combined, particularly in combination with a slide lock mechanism, can be secure and immovable relative to each other. However, it can be helpful if the proximal end of the slide sleeve is secured as well, to inhibit rotation of the slide sleeve. It can be further beneficial to have some type of support around the internal shaft that can be used when inserting the internal shaft into the channel 144.

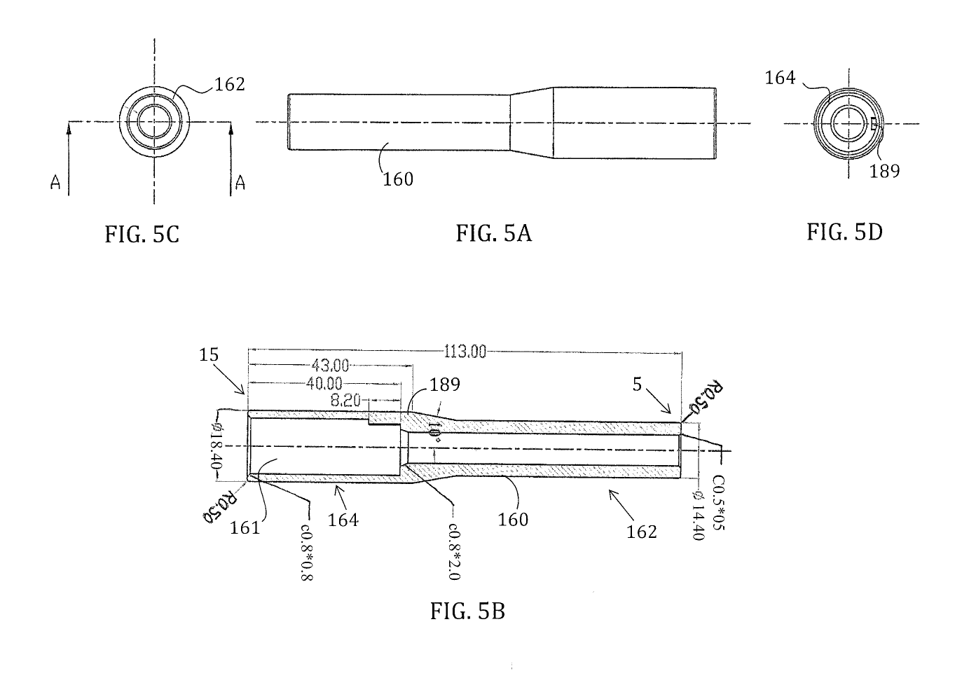

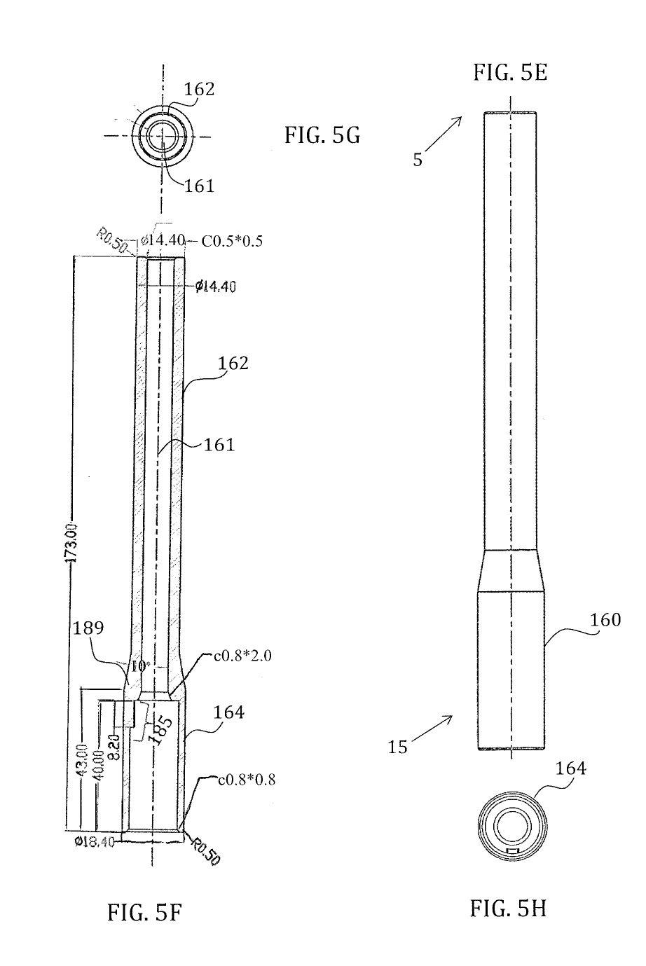

To address these issues, a lower slide sleeve 160 can be utilized on or around the internal shaft. In one embodiment, a lower slide sleeve is a tubular structure having two different internal diameters 161. FIGS. 5A-5H illustrate two embodiments of lower slide sleeves, according to the subject invention. A proximal end portion 162 of the lower slide sleeve can have an internal diameter 161 operably compatible with the diameter of an internal shaft. Ideally, the internal diameter and the diameter of the internal shaft are such that the internal shaft can slide through the internal diameter when force is applied to the internal shaft and/or the lower slide sleeve to move the lower slide sleeve relative to the internal shaft. A distal end portion 164 of the lower slide sleeve can typically have a larger internal diameter compatible with the diameter of the proximal end of an external slide sleeve, an example of which is demonstrated in FIGS. 2A and 2B. The lower slide sleeve can be positioned on an internal shaft with the distal end towards the proximal end of the internal shaft. The internal shaft can pass through the internal diameters 161 of the lower slide sleeve. Using the lower slide sleeve, the distal end of the internal shaft 120 can be inserted into the channel 144 of the external slide sleeve 140 until the diameter of the distal end portion of the lower slide sleeve couples with the proximal end of the external slide sleeve. If an attachment mechanism is utilized, the internal shaft can be inserted until the attachment mechanism is engaged.

The length of a lower slide sleeve can vary between approximately 4.0 inches to approximately 7.0 inches. Typically, the length of the distal end portion, with a larger internal diameter, is shorter than the proximal end portion, with a smaller internal diameter. In a particular embodiment, the length of the internal diameter of the distal end portion is between approximately 1.25 inches and 1.60 inches.

In a further embodiment, the external slide sleeve and lower slide sleeve can be configured with one or more alignment mechanisms 185. Alignment mechanisms can ensure that the external slide sleeve and lower slide sleeve are properly engaged and can further assist in aligning any attachment mechanisms, such as, for example, the components of a slide lock mechanism. In one embodiment, a tab and slot arrangement is employed, such that the proximal end of the external slide sleeve 140 has a cut-out or slot 187, which can be, but is not required to be contiguous with the channel 144. Conversely, the internal diameter of the lower slide sleeve can be modified with an elongate tab 189 to which the slot 187 can be fitted. When the lower slide sleeve is pushed over the external slide sleeve, the slot and tab can be aligned and as the two sleeves continue to be pushed together, the slot and tab ensure that they, and any associated attachment mechanisms on the components, are aligned. A slot and tab arrangement is one example of an attachment mechanism. Other types of attachment mechanisms which perform substantially the same function and provide substantially the same result are within the scope of this invention.

The ability of the fan to spin is provided, in part, by the upper bearing hub 200, located generally nearer to the distal end 15 of the central shaft, and the lower bearing hub 300, located generally nearer to the proximal end 5 of the central shaft, to which the tips of at least one blade can be attached. These hubs can be similar in structure. However, embodiments of the subject invention incorporate certain advantageous features in each one, such that they may not be identical.

In order that a better understanding of the operation of and relationship between the following components be understood, it will be helpful to understand the overall operation of the device. In a specific embodiment, the blades operate by bending and overlapping to form a 3-dimensionally shaped object. Ideally, then the blades are not bend and overlapping, they can be laid against one another to form a substantially flat structure that can be more easily shipped and stored. When ready to be deployed, the blades can be fanned out around the central shaft and then the proximal and distal ends of the device can be pressed together. This causes the internal shaft 120 to advance into the external side sleeve 140, bringing the upper bearing hub and lower bearing hub closer together while simultaneously causing the spines of the blades to bend or curve. In a further embodiment, as the spines of the blades bend or curve the force exerted by the bent spines on the ball joints cause the blades to turn between approximately 10° to approximately 90° relative to the central shaft. Depending upon the shape of the wing of the blade, there is effected an overlapping configuration which can create a fully 3-dimensionally shaped object. Ideally, the blades can turn sufficiently to provide the 3-dimensional effect and allow wind or air to pass between the blades so that there is further provided a turning or spinning effect by the structure of the hubs. Understanding the overall operation of the device, the individual components will now be discussed.

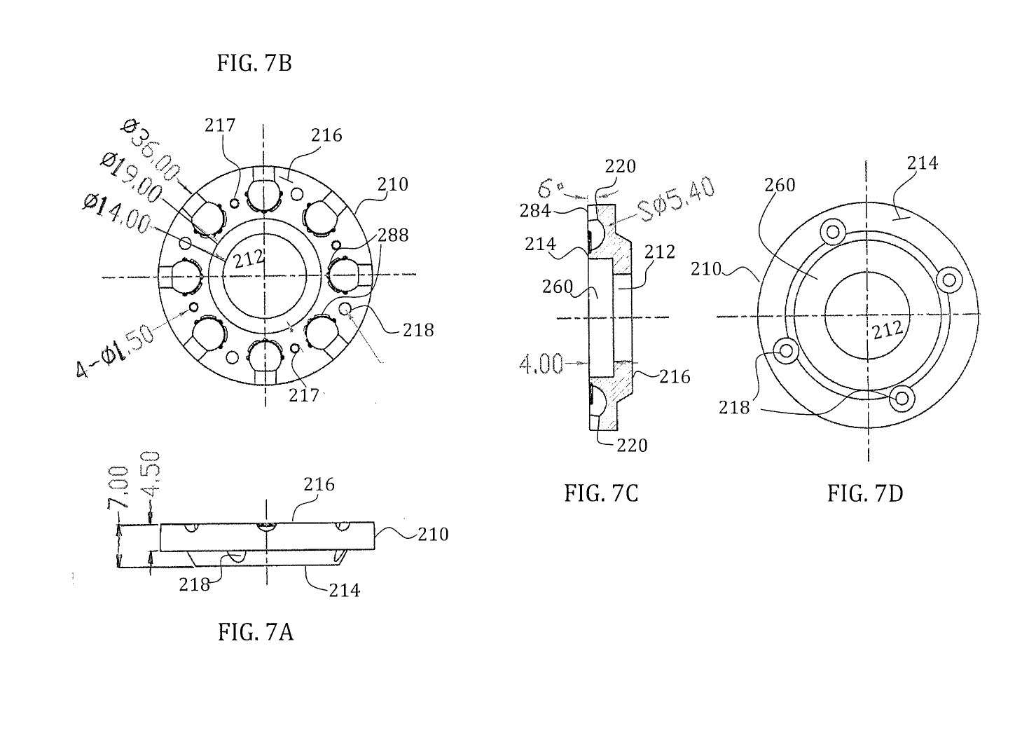

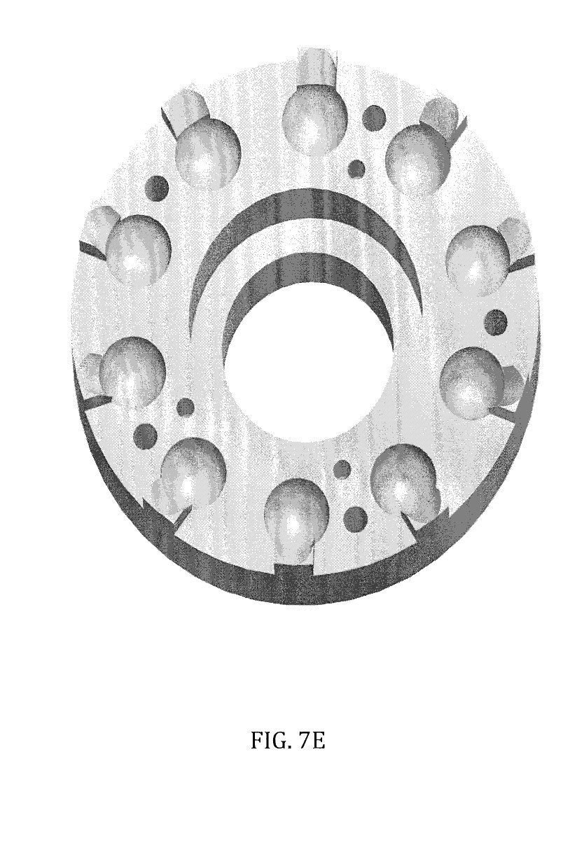

An embodiment of an upper bearing hub 200 comprises four components: a cap 210, a slotted base 250, a bearing 270, and at least one, preferably a plurality, of twist ball joints 290. FIGS. 2A, 7A-D and 8A-E show how the cap and slotted base can be operably connected to retain the bearing and the plurality of twist ball joints. The upper bearing hub can be placed over and/or around the distal end of a central shaft assembly 100. In one embodiment, the upper bearing hub is supported by the one or more annular shoulders 148 and 149 on the external slide sleeve 140, mentioned previously and shown in FIG. 2A. Ideally, the entire upper bearing hub 200 can rotate relative to the central stem 20.

When in place, the cap 210 can be located nearer the distal end of a fan assembly 10 and the slotted base 250 is located nearer the proximal end. In one embodiment, when connected to the terminal end 150 of an external slide sleeve, a top hub 155 can also operably engage with the cap to hold the fan assembly 10 together.

Referring to FIGS. 2A, 7A-D and 8A-E, it can be seen that the cap and slotted base can be joined together to form a shell-like enclosure. In one embodiment, the cap has a distal face 214 and a proximal face 216, wherein the proximal face has at least one, preferably more than one, mortise 217 that opens onto the proximal face. In a further embodiment, the slotted base 250 has a joining face 252 and a rod seat face 254, where the joining face has at least one, preferably more than one, tenon 257 that can be secured into a corresponding mortise 217 to align and assist in joining the cap and slotted base.

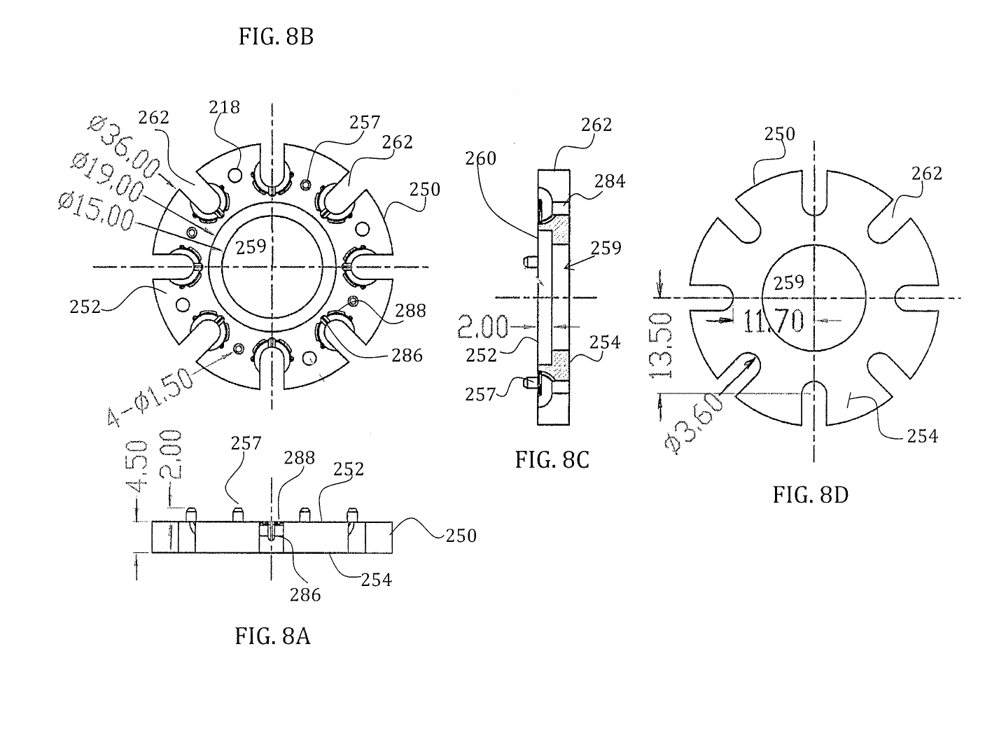

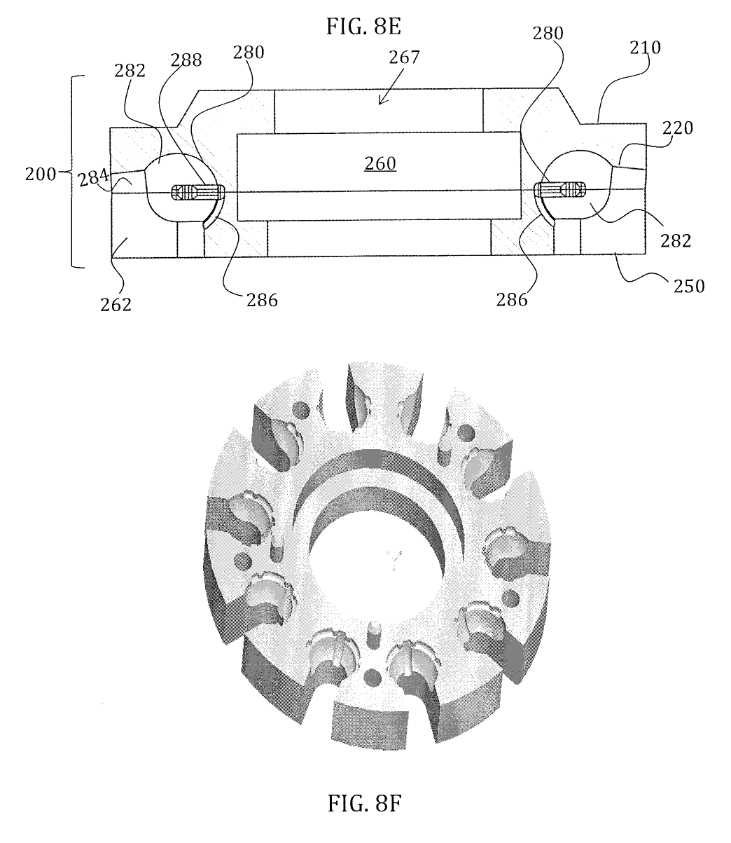

FIGS. 7B and 7C illustrate an embodiment of a cap having a counter-sunk bore 212 therethrough that opens onto the distal face 214 and onto the proximal face 216. In one embodiment, the diameter of the counter-sunk bore, where it opens onto the proximal face 216, is larger than the diameter of the bore, where it opens onto the distal face 214, shown, for example, in FIG. 7C. FIGS. 8A-8D illustrate an embodiment of a slotted base 250 having a corresponding double-bore 259. Similarly to the cap, the diameter of the double-bore where it opens onto the joining face 252 is larger than the diameter of the double-bore where it opens onto the rod seat face, as shown, for example, in FIG. 8C. In one embodiment, when the proximal face 216 on the cap and the joining face 252 on the slotted base are juxtaposed, the larger diameter area within the counter-sunk bore 212 and the larger diameter area in the double-bore are joined to form a central conduit 267, shown, by way of example, in FIG. 8E.

In a further embodiment, one or more mortis 217 and tenon 257 on these respective surfaces are engaged with each other. The cap and slotted base can be maintained in a juxtaposed position by the force of the top hub 155 joined with the terminal end 150. Alternatively, the cap and slotted base can be attached by an adhesive. In another alternative, the cap and slotted base can be magnetized or have magnets therein that hold the components together. In still another alternative embodiment, the cap and slotted base can have one or more aligned holes 218 into which a connector, such as a screw, pin, rod, or the like, can be inserted to hold the two components together. Other variations for holding the cap and slotted base together are known to those with skill in the art and are within the scope of this invention.

The conduit 267 allows the terminal end 155 of an external slide sleeve to traverse the upper bearing hub 200 to emerge on the distal side 15, where it can be joined to the top hub 155, an example of which is shown in FIG. 2A. Further, when the larger diameter area of the counter-sunk bore at the proximal face of the cap joins with the larger diameter area of the double-bore at the distal end of the slotted base 250 there is also formed a bearing chamber 260 into which a bearing 270 can be seated, an example of which is shown in FIG. 2A. The bearing can allow the upper bearing hub 200 to rotate on the central stem 20 and, in a particular embodiment, on the terminal end 150 of the external slide shaft 140. Ideally, the bearing and bearing chamber are sized so that the bearing can operate unimpeded. In one embodiment, the bearing chamber is configured to receive a bearing with minimal tolerance therebetween, so that the bearing is held firmly. Alternatively, the bearing chamber is sized to receive the bearing with sufficient tolerance therebetween that the bearing allows rotation of the terminal end 150 as well as rotation of the bearing within the bearing chamber. For installation, a bearing can be placed in one of the larger diameter areas prior to the cap and slotted base being joined. In one embodiment, a ring ball-bearing is employed in the bearing chamber. In an alternative embodiment, a ringed surface-bearing, such as one comprising a material having a low coefficient of friction, is utilized. In a further ideal, the bearing utilized will be amenable for use under outdoor conditions. Alternatively, bearings designed for a more protected environment could also be utilized. A variety of surface, line, and point contact bearings can be utilized with the embodiments of the subject invention. Such variations are within the scope of this invention.

In a further embodiment, when the cap 210 and the slotted base 250 are joined, there is also formed at least one, preferably a plurality, of sockets 280 into which at least one, preferably a plurality, of twist ball joints 290 can be retained. In one embodiment, a socket is a generally spherical void 282 with a trench 284 that communicates the spherical void with the exterior of the upper bearing assembly 200. A socket can permit a twist ball joint 290 to rotate and translate. In a specific embodiment, a plurality of sockets and associated trenches are arranged in the upper bearing assembly, such that a plurality of twist ball joints therein extend equidistantly from the periphery of the upper bearing assembly, such as shown, for example, in FIGS. 2B and 2C.

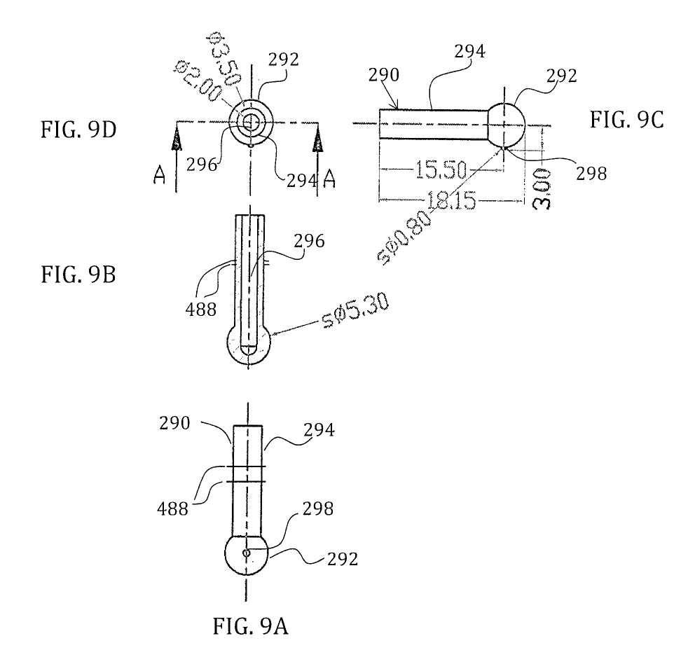

As will be explained below, at least one blade will be operably connected to a spherical void, allowing it to be rotated and/or translated into the appropriate direction for display. This is accomplished by attaching the blade ends to a twist ball joint 290, which can be, in turn, operably joined to a socket 280. In one embodiment, a twist ball joint is, generally, a sphere 292 with an arm 294 extending therefrom, and a duct 296 within the arm and/or part of the sphere. One embodiment of a twist ball joint is shown in FIGS. 9A, 9B, and 9C. Ideally, the diameter of the spherical void 282 is configured to allow the twist ball joint to rotate while still retaining the twist ball joint securely within the socket.

In one embodiment, the cap 210 is formed with a distal portion of the spherical void 282 and trench, and the slotted base is formed with a proximal portion of the spherical void and trench. In one embodiment, the cap and slotted base each form one half of the spherical void. This allows the twist ball joint to be positioned in either the cap or slotted base prior to the cap and slotted base being assembled. In a further embodiment, the arm 294 on the twist ball joint is positioned within that portion of the trench 284 formed by either the cap or the slotted base, so that when assembled, the arm extends from the completed trench. FIG. 2A illustrates one embodiment of this configuration.

During installation of the blades, it can be helpful for the twist ball joint to be capable of translation as well as rotation within the socket. However, in order to maintain the position of the blades, it can be further beneficial if the twist ball joint can be secured into one position. In one embodiment, all or most of the trench extends proximally to open onto the proximal end of the slotted base. Thus, when viewed from a proximal or distal plan view, the slotted base 250 appears to have at least one, preferably multiple cut-outs or proximal translation slots 262 around the edges of the slotted base, an example of which is shown in FIGS. 8B and 8D. In a further embodiment, the diameter of the trench and the proximal translation slot is smaller than the diameter of the spherical void 282, in particular the diameter of the spherical void portion within the slotted base. This can allow the sphere to be secured within the spherical void, while simultaneously being able to translation and/or rotate relative to the spherical void. In one embodiment, the arm of a twist ball joint can translate within the trench and the proximal translation slot, such that the arm can extend laterally, relative to the central stem, and translate proximally until the arm is approximately parallel to the central stem. FIG. 2A illustrates this embodiment, with the arms extending in a maximum lateral direction. It can be seen in this view that the proximal translation slot 262 can allow the arm 296 to rotate proximally 5, while the sphere 292 is still retained in the spherical void 282.

In one embodiment, the arm can translate between approximately 0° proximally to approximately 90° laterally, between the central stem and a distal edge 220 of the trench. In a more specific embodiment, the arm can translate between about 0° proximally to about 84° laterally, between the central stem and a distal edge 220 of the trench. This can facilitate installation of the one or more blades and angle of the trench and proximal translation slot ensure that the blade maintains a desired 3-dimensional configuration.

As mentioned above, the ability of the arm to rotate and translate can benefit installation of one or more blades and/or shipping and storage of the fan assembly. However, once the blades are emplaced, it can be further beneficial for the arms to be secured in one desired position, so that the blades are also maintained in position. In a further embodiment, the spherical void 282 within the upper hub assembly is configured with one or more furrows. In a still further embodiment, the sphere of a twist ball joint is configured with at least one nub 298 that can be operatively engaged with the one or more furrows.

As discussed above, the proximal translation slot and/or trench allow the arm to translate proximally 5. In a further embodiment, the spherical void is configured with at least one latitudinal furrow 286. In a specific embodiment, the slotted base 250 has at least one latitudinal furrow 286 within that portion of the spherical void formed within the slotted base. In a further specific embodiment, the at least one nub 298 on the sphere 292 of a twist ball joint is operatively engaged with the latitudinal furrow 286. In use, the nub travels along the path of the latitudinal furrow, as the arm translates laterally, relative to the central stem. FIGS. 8A, 8B, 8C, and 8E illustrate one embodiment of a latitudinal furrow 286. FIG. 2A illustrates an embodiment of a nub engaged with a latitudinal furrow.

In order to secure the position of a blade, the ability of the arm to translate can be inhibited or at least restricted. This can entail preventing the nub from traversing along the latitudinal furrow, inhibiting translation of the arm. In one embodiment, the latitudinal furrow is contiguous with at least one longitudinal furrow 288 that allows the sphere 292 to rotate along a longitudinal path in the spherical void. In a more specific embodiment, the longitudinal furrow 288 is located at or about, and traverses at least part of, the hemisphere of the spherical void. In a particular embodiment, a portion of the longitudinal furrow is formed within the cap 210 and another portion of the longitudinal furrow is formed within the slotted base. When the cap and slotted base are joined, as described above and as shown in FIG. 8E, the complete longitudinal furrow is created. In use, when the arms are positioned proximally, the nub 298 will be aligned with the longitudinal furrow, allowing the sphere to be rotated in at least one, preferably two directions along the hemisphere of the spherical void. In one embodiment, an arm is positioned at between approximately 0° and approximately 10° for hemispherical rotation. In a more specific embodiment, an arm is positioned at between approximately 0° and approximately 5° for hemispherical rotation.

When the proximal 5 and distal ends 15 of the central shaft are pressed together, as described above, the force exerted on the twist ball joints can cause them to rotate and translate with the sockets. The latitudinal and longitudinal furrow can assist in aligning the twist ball joints, to which the blade ends are operably connected. When the blade spines bend and exert force, the longitudinal furrow causes the twist ball joints to rotate, which in turn, causes the blades to turn to the correct angle for overlapping. When force is released, the latitudinal furrow ensures that the arm of the twist ball joint is properly aligned with the proximal translation slot, which allows the blade spine to straighten. Further, the blades can rotate so that they can be laid against one another. In summary, the latitudinal and longitudinal furrows aid in aligning the twist ball joints, and thus the blades, when the hubs are pressed together.

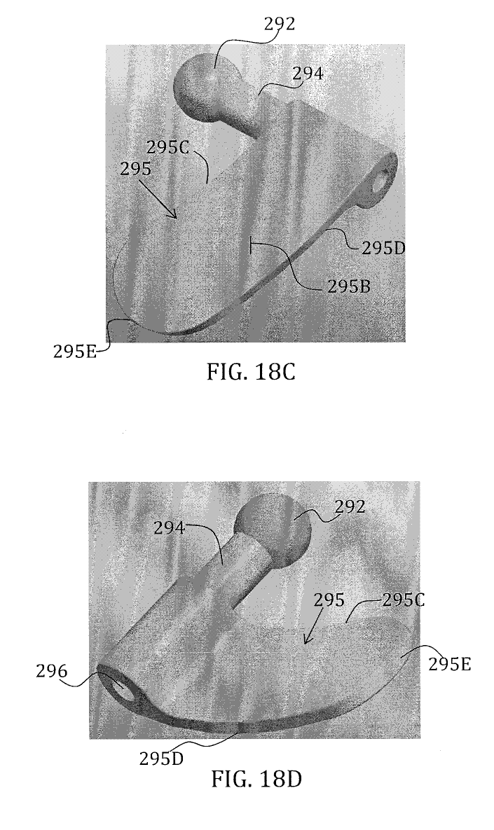

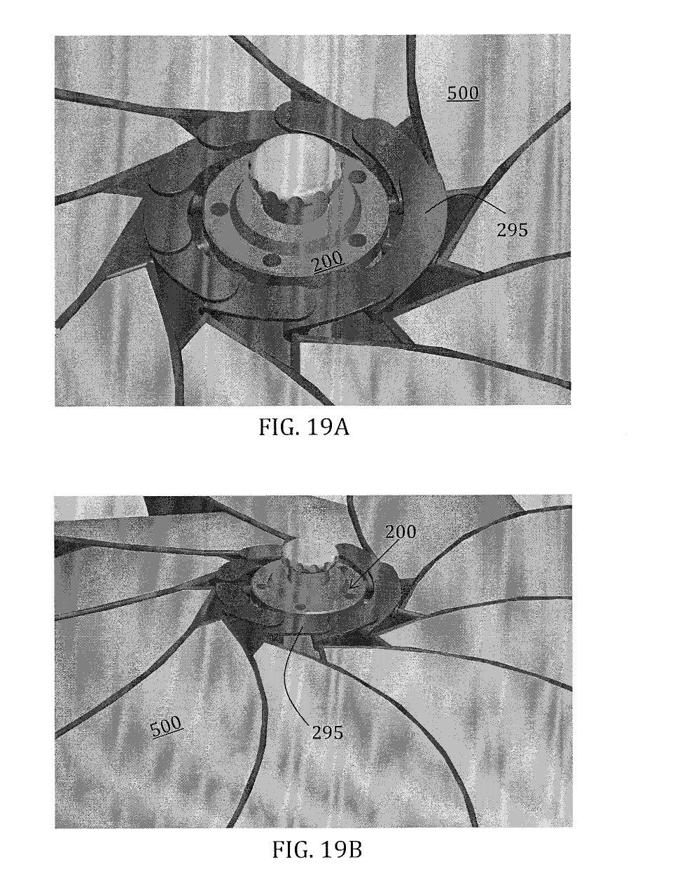

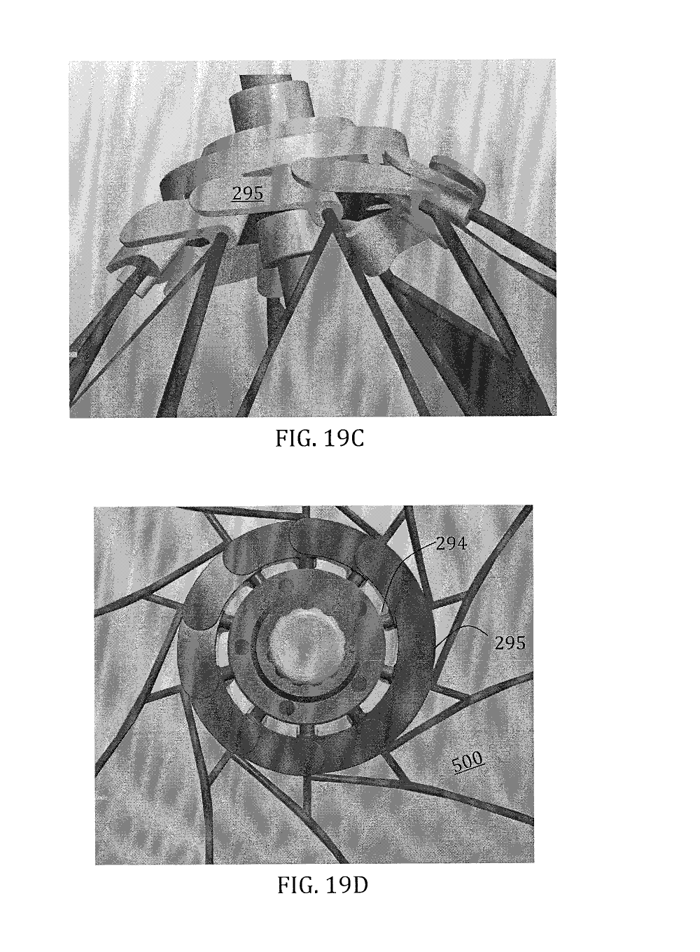

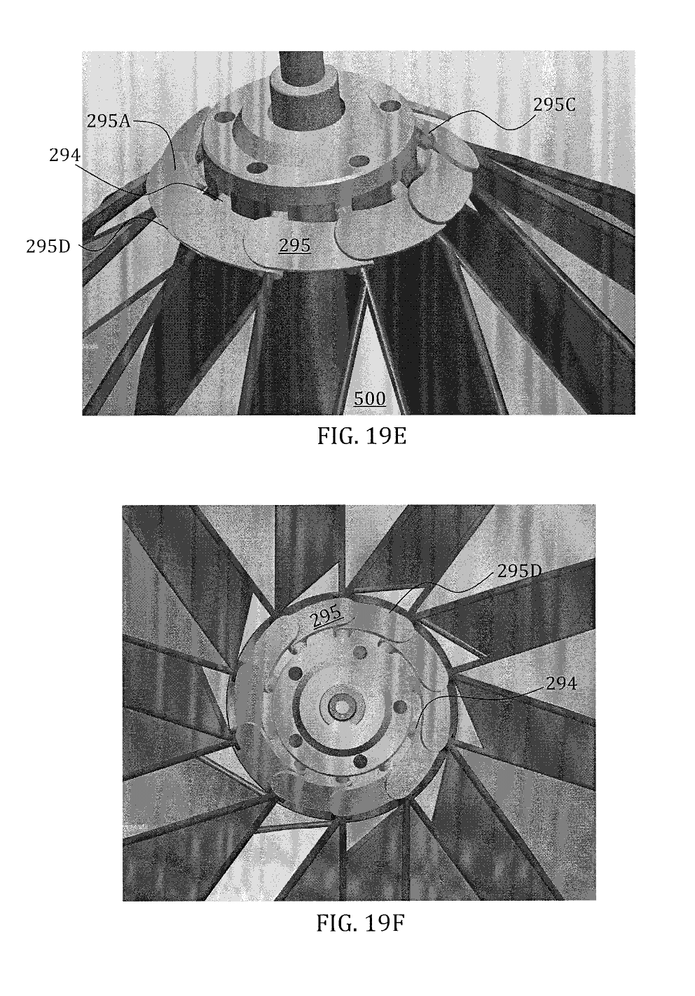

To further facilitate proper alignment of the blades, a twist ball joint 290 can further incorporate an alignment fin 295. In one embodiment, an alignment fin is a flat flange-like attachment or extension that protrudes from the arm 294 of a twist ball joint. An alignment fin can have an upper side 294A and a bottom side 294B can assume any of a variety of circumferential shapes 294C. FIGS. 18A, 18B, 18C, and 18D illustrate one embodiment of an alignment fin. The purpose of an alignment fin is to assist the positioning of the blades when the hubs are pressed together. As mentioned above, the twist ball joint can rotate to align the blades in an overlapping configuration to assume the 3-dimensional effect. The alignment fins can be shaped so that they overlap and encircle the upper bearing assembly 200, as shown, for example, in FIGS. 19A-19F.

In one embodiment, the alignment fin extends perpendicularly from the arm 294 with the upper side 295A and bottom side 295B parallel to the arm, as shown, in the examples in FIGS. 18A-D. In an embodiment where the sphere 292 includes a nub 298, the alignment fin can extend lateral to the nub, and shown in the example in FIG. 18A. This allows the nub to rotate in the latitudinal furrow 288 as described above, which will cause the alignment fins to simultaneously overlap around the upper bearing assembly. In a further embodiment, the upper side and lower side are bowed or curved towards the bottom side, such that the bottom side 295B is slightly concave. When the alignment blades are overlapped, as shown in FIG. 19E, the curvature allows the bottom side of one alignment fin to lay flush against the upper side of the adjacent alignment fin, which is illustrated by way of example in FIG. 19C.

The alignment fins 295, when overlapped, will form a circular array around the upper bearing hub. The circumferential shape of an alignment fin, that is the shape of the upper edge 295C and outer edge 295D and terminal end 294E, can assume any of a variety of shapes, so long as it does not inhibit the alignment fins from overlapping and assisting with alignment of the blades. FIGS. 19A-19E illustrate one embodiment where the alignment fin is essentially an elongated tab with a rounded terminal end 294E. To provide a more uniform circular appearance, the edges of the alignment fin can be curved appropriately. In on embodiment, the upper edge is and lower edge are curved away from the sphere 298, such that the upper edge 295C has more concave shape and the outer edge 295D has a more convex shape. The amount of curvature imparted to each edge will depend upon the diameter of the upper bearing hub and the effect to be achieved. Typically, the curvature is such that when the alignment fins are overlapped, they create a uniform circular shape around the upper bearing hub, as shown, for example, in FIGS. 19D and 19F. A person with skill in the art would be able to determine other shapes that could also be employed to provide different aesthetics or design effects.

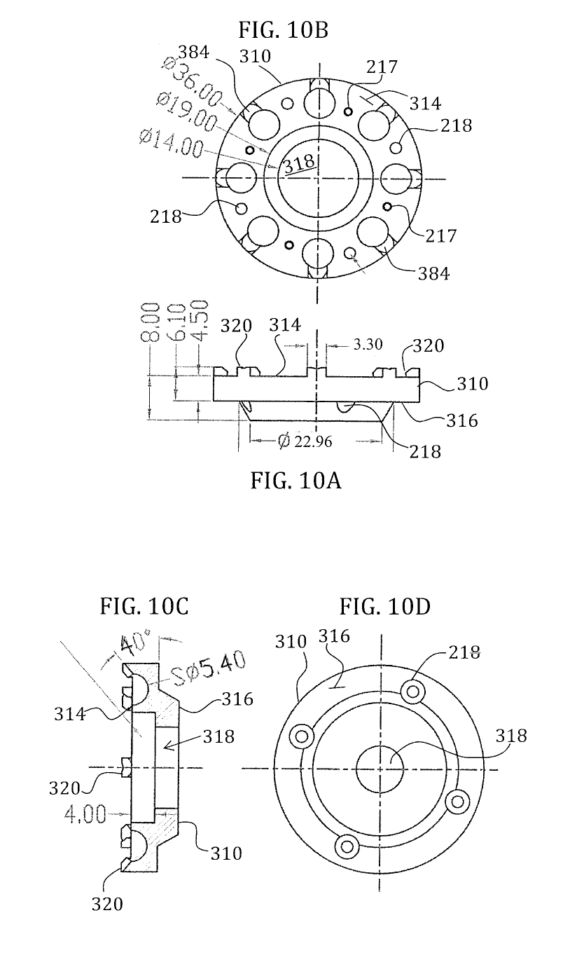

A lower bearing assembly 300 is utilized in conjunction with the upper bearing assembly 200 to secure the ends of at least one, preferably a plurality of, blade. In particular, the lower bearing assembly is utilized to secure the proximal end of at least one, preferably a plurality of, blades. One embodiment of a lower bearing hub 300 comprises four components: a base 310, a slotted cap 350, a bearing 370, and a plurality of ball joints 390. FIGS. 2B, 10A-D and 11A-E demonstrate how the cap and slotted base can be operably connected to retain the bearing and the plurality of ball joints. The lower bearing hub can be placed nearer to the proximal end of a central shaft assembly 100 than the upper bearing hub, which is placed closer to the distal end 15. Ideally, the entire lower bearing hub 300 can rotate relative to the central stem 20, preferably in tandem with the upper bearing hub rotation.

When in place, the base 310 can be located towards the proximal end of a fan assembly 10 and the slotted cap 350 can be located towards the proximal end. In one embodiment, when connected to the central stem, particularly the internal shaft, one or more securing mechanisms 400 can be used to inhibit sliding or other movement. Securing mechanisms 400 and the factors that can be considered by those skilled in the art with regard to type utilized with components of the subject invention have been discussed above and are reasserted here. In a particular embodiment, a securing mechanism is a clip secured to the central stem and proximally to the lower bearing assembly. In a further specific embodiment, the securing mechanism is a clip, where one is secured to the central stem proximally to the lower bearing assembly and another is secured to the central stem distal to the lower bearing assembly. FIGS. 12A-13F illustrate embodiments of clips that can be utilized with the subject invention. FIG. 2B demonstrates how the clips can be positioned on a central stem to secure a lower bearing assembly. FIGS. 3D and 3E illustrate an embodiment of an internal shaft 120 with coupling features that cooperate with one or more securing mechanisms.

Referring to FIGS. 2B, 10A-D, and 11A-E, it can be seen that the base and slotted cap can be joined together to form a shell-like enclosure, similar to that of an upper bearing assembly 200. In one embodiment, the base has a distal face 314 and a proximal face 316, wherein the distal face 314 has at least one, preferably more than one, mortise 217 that opens onto the distal face. In a further embodiment, the slotted cap 350 has a connecting face 352 at the proximal end 5 and an exit face 354 at the distal end 15, where the connecting face has at least one, preferably more than one, tenon 257 that can be secured into a corresponding mortise 217 on the distal face 352 of the base 310 to align and assist in joining the base and slotted cap.

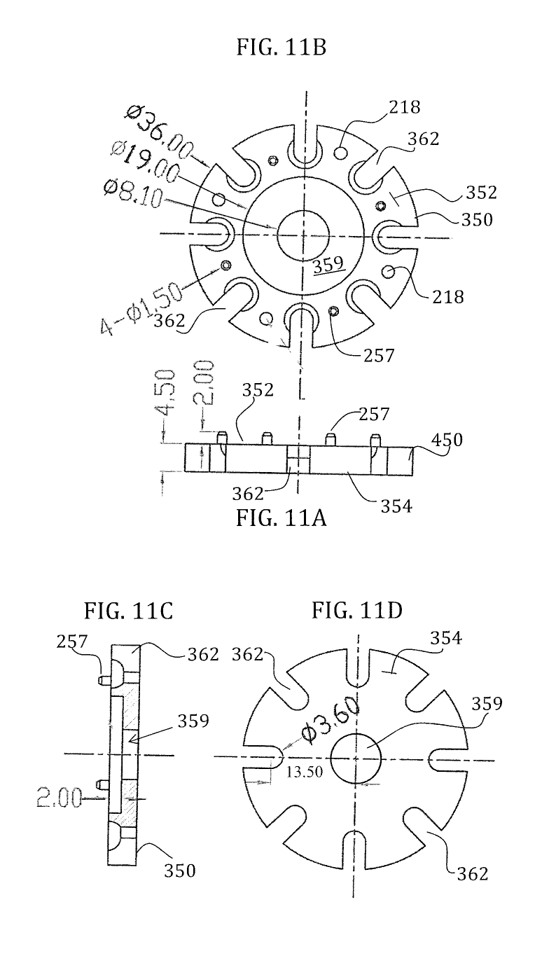

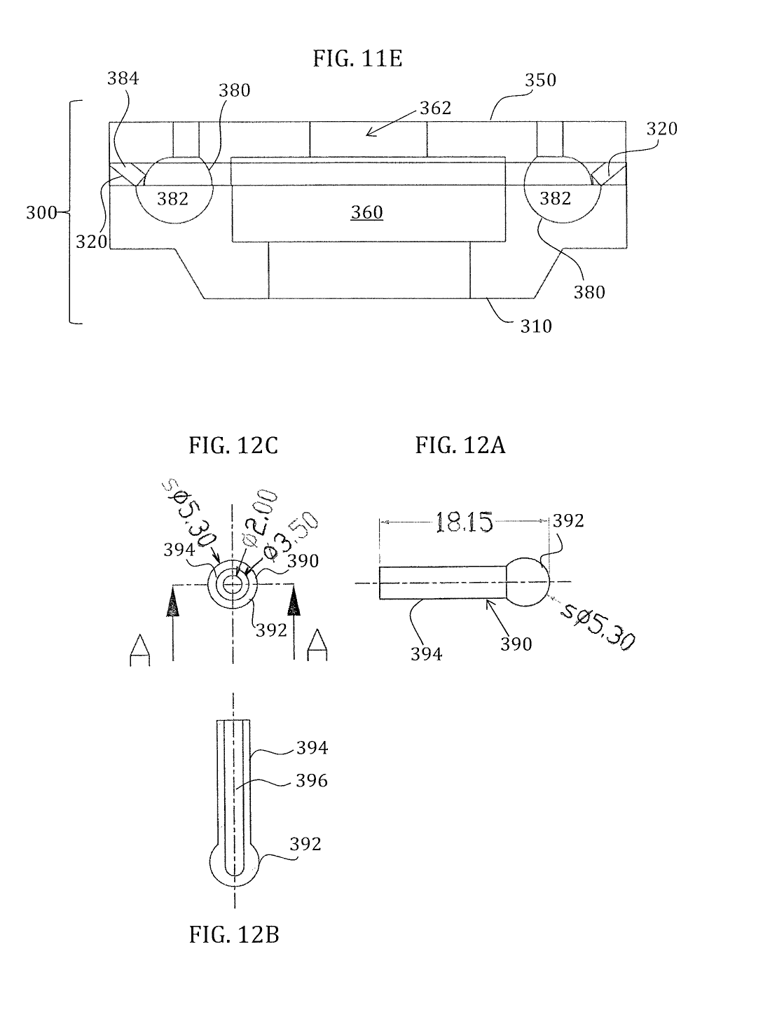

FIGS. 10B and 10C illustrate an embodiment of a base having a dual-bore 318 therethrough that opens onto the distal face 314 and the proximal face 316. In one embodiment, the diameter of the dual bore, where it opens onto the distal face 314, is larger than the diameter of the bore, where it opens onto the proximal face 316, shown, for example, in FIGS. 10B and 10C. FIGS. 11A-11C illustrate an embodiment of a slotted cap 350 having a corresponding twin-bore 359. Similarly to the base, the diameter of the twin-bore where it opens onto the connecting face 352 is larger than the diameter where it opens onto the exit face 354, as shown, for example, in FIGS. 11A and 11C. In one embodiment, when the distal face 314 on the base and the connecting face 352 on the slotted cap are joined, the larger diameter area within the dual-bore 318 and the larger diameter area in the twin-bore are juxtaposed to form an passageway 362, shown, by way of example, in FIG. 11E.

In a further embodiment, the mortise 217 and tenon 257 on these respective surfaces are engaged with each other. The base and slotted cap can be maintained in a joined position by a variety of devices and techniques. In one embodiment, they can be attached by an adhesive. In another embodiment, the cap and slotted base can be magnetized or have magnets therein that hold the components together. In still another alternative embodiment, mentioned above with regard to the upper bearing assembly, the base and slotted cap can have one or more aligned holes 218 into which a connector, such as a screw, pin, rod, or the like, can be inserted to hold the two components together. Other variations for holding the cap and slotted base together are known to those with skill in the art and are within the scope of this invention.

In one embodiment, the passageway 362 allows the internal shaft 120 to traverse the lower bearing hub, an example of which is shown in FIG. 2B. Further, when the larger diameter area of the dual-bore 318 at the distal face of the base 310 joins with the larger diameter area of the twin-bore 359 at the proximal end of the slotted cap 350 there is formed a bearing seat 360, similar to the bearing chamber 260 formed in the upper bearing assembly, into which a bearing 270 can be seated, an example of which is shown in FIG. 2B. The bearing can allow the upper bearing hub 200 to rotate on the internal shaft 120 and, in a particular embodiment, between one or more securing mechanisms 400 on the internal shaft.

Ideally, the bearing and bearing seat are sized so that the bearing can operate unimpeded. In one embodiment, the bearing chamber is configured to receive a bearing with minimal tolerance therebetween, so that the bearing is held firmly. Alternatively, the bearing seat is sized to receive the bearing with sufficient tolerance therebetween that the bearing allows rotation of the internal shaft 120, as well as rotation of the bearing within the bearing seat. For installation, a bearing can be placed in one of the larger diameter areas prior to the base and slotted cap being joined. In one embodiment, a ring ball-bearing is employed in the bearing seat. In an alternative embodiment, a ringed surface-bearing, such as one comprising a material having a low coefficient of friction is utilized. In a further ideal, the bearing utilized will be amenable for use under outdoor conditions. Alternatively, bearings designed for a more protected environment could also be utilized. A variety of surface, line, and point contact bearings can be utilized with the embodiments of the subject invention. Such variations are within the scope of this invention.

In a further embodiment, when the base 310 and the slotted cap 350 are joined, there is also formed at least one, preferably a plurality, of sockets 380 into which at least one, preferably a plurality, of ball joints 390 can be retained. In one embodiment, a socket is a generally spherical void 382 with a trench 384 that communicates the spherical void with the exterior of the upper bearing assembly 300. A socket can permit a ball joint 390 to rotate and translate. In a specific embodiment, a plurality of sockets and associated trenches are arranged in the lower bearing assembly, such that a plurality of ball joints therein extend equidistantly from the periphery of the lower bearing assembly, such as shown, for example, in FIGS. 2B and 2C.

As will be explained below, at least one blade will be operably connected to a spherical void, allowing it to be rotated and or translated into the appropriate position for display. This is accomplished by attaching the blade ends to a ball joint 390, which can be, in turn, operably joined to a socket 380. In one embodiment, a ball joint is, generally, a sphere 392 with an arm 394 extending therefrom, and a duct 396 within the arm and/or part of the sphere. One embodiment of a ball joint is shown in FIGS. 12A, 12B, and 12C. Ideally, the diameter of the spherical void 382 is configured to allow the ball joint to rotate while still retaining the ball joint securely within the socket.

In one embodiment, the base 310 is formed with a distal portion of the spherical void 382 and trench 384 and the slotted cap is formed with a proximal portion of the spherical void and trench. In one embodiment, the cap and slotted base each forms approximately one half of the spherical void. This allows the ball joint to be positioned in either the base or slotted cap prior to the base and slotted cap being assembled. In a further embodiment, the arm 394 on the ball joint is positioned within that portion of the trench 384 formed by either the base or the slotted cap, so that, when assembled, the arm extends from the trench. FIGS. 2B and 2C illustrate one embodiment of this configuration.

During installation of the blades, it can be helpful for the ball joint to be capable of translation as well as rotation within the socket. More specifically, it can be helpful for the arms of a ball joint to be able to also translate in a proximal to distal direction, to facilitate attachment of different styles of blades. In one embodiment, all or most of a trench extends distally along its length, to open onto the distal end of the slotted cap. Thus, when viewed from a proximal or distal plan view, the slotted cap appears to have at least one, preferably multiple, cut-outs or distal translation slots 362 around the edges of the slotted base, an example of which is shown in FIGS. 11B and 11D. In a further embodiment, the diameter of the trench and the distal translation slot is smaller than the diameter of the spherical void 382, in particular the diameter of the spherical void portion within the slotted cap. This can allow the sphere to be secured within the spherical void, while simultaneously allowing the arm 394 to translate in the distal translation slot. In one embodiment, the ball joint can translate within the trench and the distal translation slot, such that the arm can extend laterally, relative to the central stem, and rotate distally until the arm is approximately parallel to the central stem. FIG. 2B illustrates this embodiment, with the arms extending in a maximum lateral direction. It can be seen in this view that the distal translation slot 362 allows the arm 394 to rotate proximally 5, while the sphere 392 is still retained in the spherical void 382.

In one embodiment, the arm can translate between approximately 0° distally to approximately 90° laterally, between the central stem and a distal edge 320 of the trench. In a more specific embodiment, the arm can translate between about 0° proximally to about 50° laterally, between the central stem and a distal edge 320 of the trench. This can make installation of the one or more blades easier. The angle of rotation can also ensure that the blades hold a desired 3-dimensional configuration.

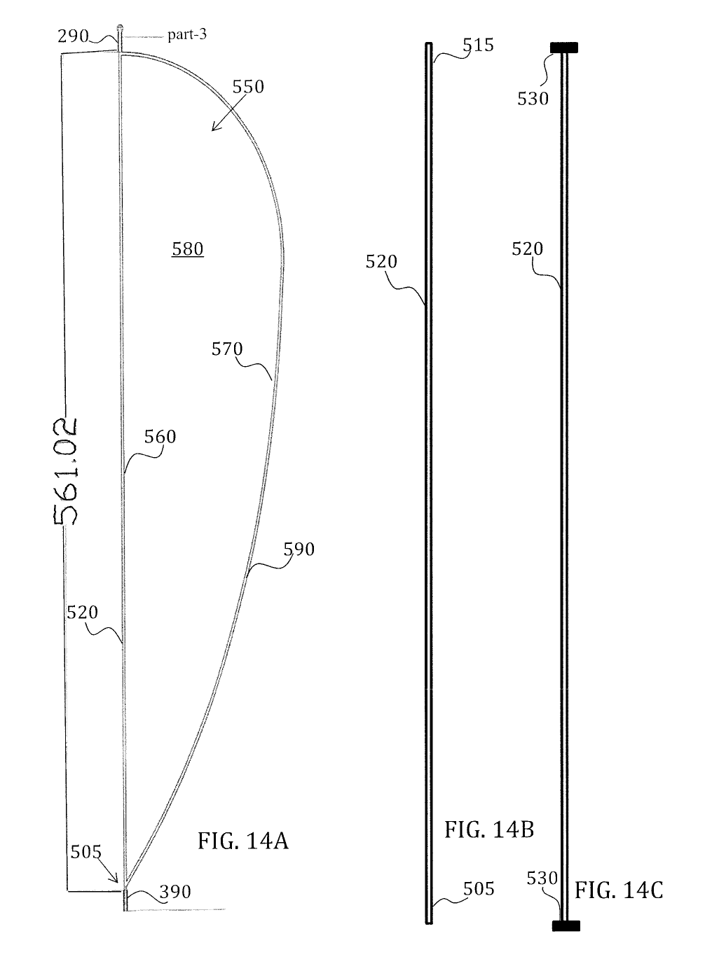

Referring now to FIGS. 14A and 14B, a blade assembly 500 is designed to be operatively connected to the upper bearing assembly 200 and lower bearing assembly 300, as mentioned above. FIGS. 14A and 14B illustrate a blade assembly having a spine 520 to which is attached a blade 550, a twist ball joint 290 at the distal tip 515 of the spine and a ball joint 390 at the proximal tip 505 of the spine. In an alternative embodiment, the twist ball joint and ball joint are not attached to the respective tips of a spine, but are rotatably and/or translatably coupled to the respective bearing assemblies, as described above. With this alternative embodiment, the tips of the spine can be inserted into the ducts 296 and 396 in the ball joints.

The spine 520 of a blade assembly can support the blade 550, both during installation and when spinning. The spine also acts as the biasing element between the hubs and can help engage an attachment mechanism between the internal shaft and the external slide shaft. Thus, the spine should have sufficient rigidity to exert force between the hubs and maintain the 3-dimensional shape imparted to the fan assembly by the configuration of the multiple blades. The spine should also have sufficient flexibility, so that it can bend, at least partially, permitting one or more of the blade ends to be inserted into or placed within the sockets. In one embodiment, the spine is formed of a shape-memory material that allows it to bend at least partially, but is biased towards a linear configuration. This can beneficially provide a spring-action to the spine that can assist in holding the tips in the ducts. In a further embodiment, the ability of the spine to bend contributes to the 3-dimensional shape of the fan assembly. It is within the skill of a person trained in the art to determine any of one or more materials that would be useful for a spine. Such variations are within the scope of this invention.

In one embodiment, the spine is substantially linear, as shown, for example, in FIGS. 14A and 14B. Alternatively, the spine can have a curve, bend, angle, or other shape imparted thereto, such that it is not linear, but still provides support and shape to the blade. The circumferential shape of a blade can also vary and is not limited to the substantially circular shape shown in FIGS. 14A and 14B. It would be within the skill of a person trained in the art to determine an appropriate shape for a spine, so that it provides support to the blade, and also, if desired, can contribute to the 3-dimensional shape of the fan assembly.

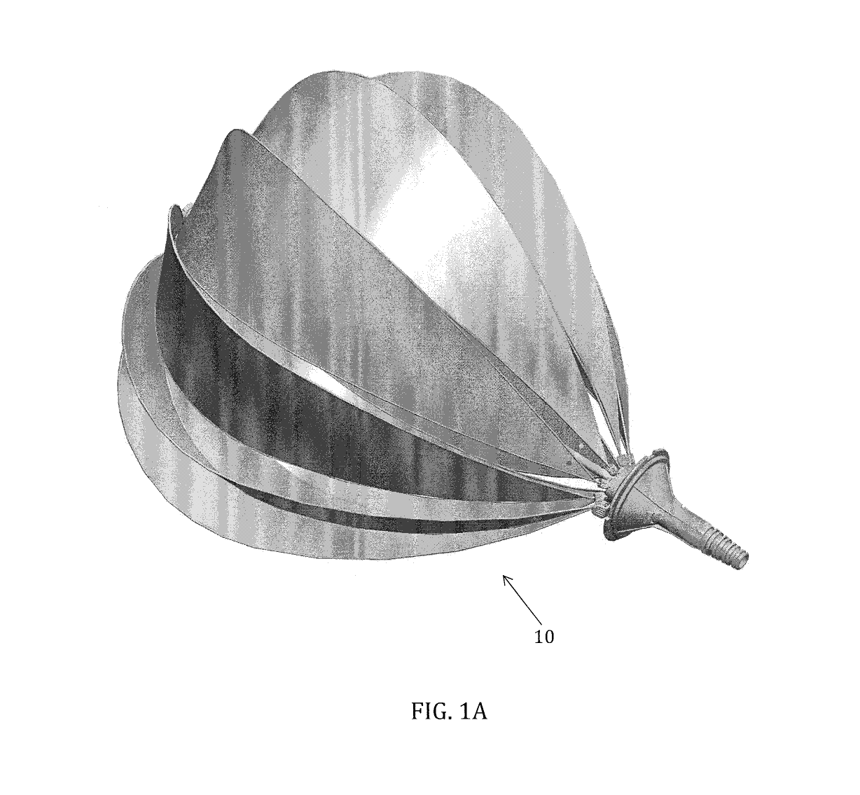

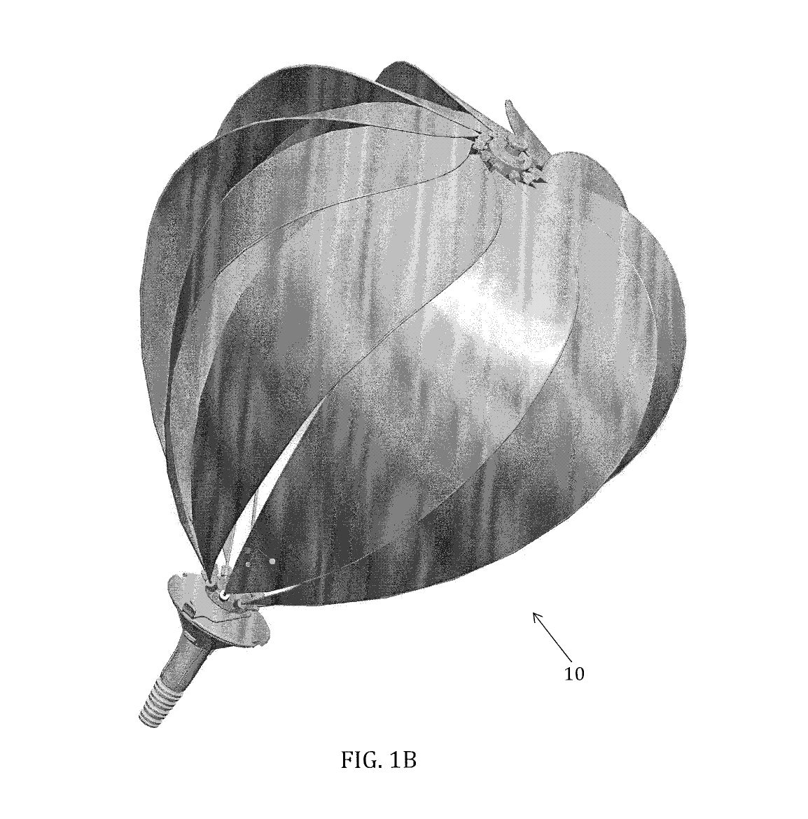

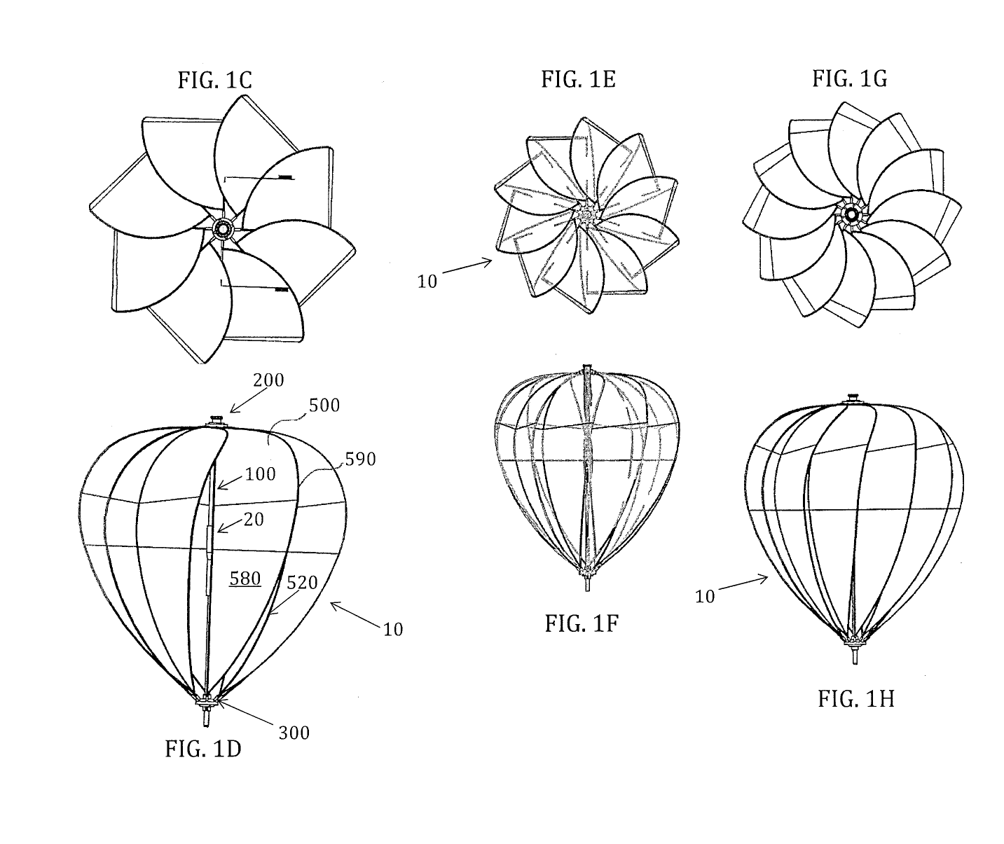

Typically, it is the blade 550 that provides the 3-dimensional shape to a fan assembly. FIGS. 1A-1G illustrate embodiments where multiple blade assemblies are utilized to provide a fan assembly with different 3-dimensional shapes and appearances. In one embodiment, a blade has an inside edge 560 positioned nearest to the shaft assembly 100 and an outside edge 570 located furthest from the shaft assembly, wherein the inside edge and the outside edge define a wing 580 therebetween. In a further embodiment, at least a portion of the inside edge is attached to the spine. In one embodiment, the inside edge is fixedly attached or is formed as a non-removable part of the spine. In another embodiment, the inside edge is removably coupled to the spine, such that the blades can be removed from a spine. This allows the blades to be changed and replaced.

When the blade assembly is attached to a central stem 20, the spine 520 is operably attached to the upper and lower bearing assemblies by the ball joints. In one embodiment, the length of the spine is such that when substantially parallel to the central stem, causing the wing and outside edge to extend substantially laterally from the spine, the spine will remain operably connected at each end to the respective ball joint or twist ball joint. With this embodiment, when internal shaft 120 and external slide sleeve 140 are at their maximum extension, the spines of the blades will remain parallel to the central stem.

In further embodiment, when multiple blade assembly are attached to the central stem 20, the length of the spines 520 are such that when the hubs are pushed or pressed closer together, the spines can bend or bow away from the central stem. With this embodiment, the twist ball joint and longitudinal furrow assist in rotating the spine, causing the wing 580 to turn more perpendicular to the central stem. Further, the bending of the spine can also cause the perpendicular wing 580 to bend as well, as shown, for example, in FIGS. 1A-1G. Still further, when multiple blades are attached to the central stem, depending upon the size and shape of their wings, they may overlap, forming the appearance of a closed 3-dimensional object. FIGS. 1A-1F illustrate examples of this particular embodiment. Ideally, as air pushes against and moves over the wings 580 of the blade, the fan assembly 10 can spin, due to the upper and lower bearing assemblies.

Thus, the shape of the outside edge and/or the shape of the wing can impart an overall 3-dimensional shape to a fan assembly. Further, the shape of the spine when installed between the upper and lower bearing assemblies can also contribute to the shape of the fan assembly. FIGS. 1A-1G illustrate specific embodiments of a fan assembly in the shape of an inflatable balloon. But, a person with skill in the art and having benefit of this disclosure could devise any of a variety of blade shapes to create 3-dimensional shapes for a fan assembly.

The attachment of the blades to the upper and lower bearing assemblies, by means of the ball joints 290 and 390 can be accomplished by several methods. It can be preferable for the proximal tip 505 and distal tip 515 of the blades to be attached to the ball joints in a somewhat secure fashion. Otherwise, as the blades are assembled and more are attached, it can become more difficult to prevent them from becoming unattached before all of them can be put in place around the central stem.

In one embodiment, the ball joints have ducts 296 and 396 into which the respective ends of the blade spines can be inserted. FIG. 14A illustrates an example of this embodiment. This could allow the blades to be completely removed from the central stem by simply bending the spines. Alternatively, the ends can be further secured within the ducts by any one or more of a variety of adhesive products or sealing or joining methods, such as, for example, heat sealing or crimping, or other methods known to those with skill in the art. The spine ends could also be directly, attached to the arms 294 and 394 of the ball joints by any of a variety of adhesives or sealing or joining methods.

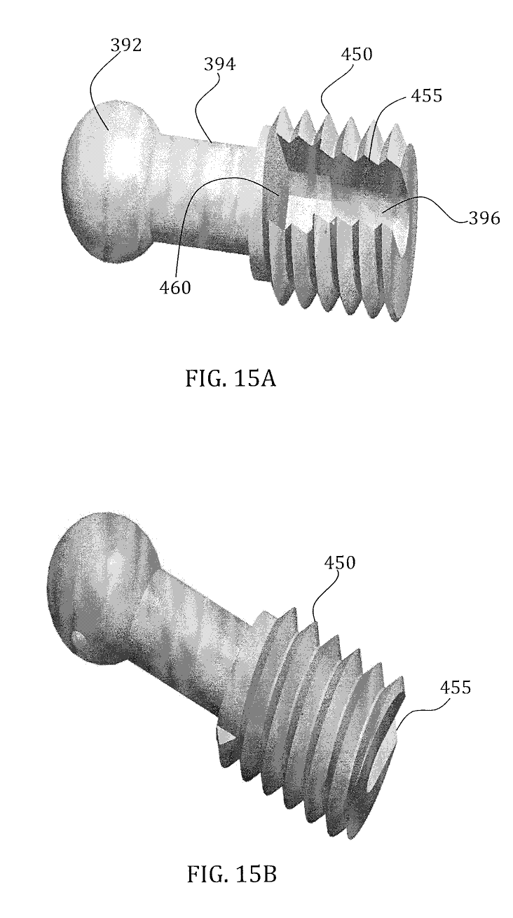

In a specific embodiment, the arms 294 and 394 of the twist ball joints 290 and ball joints 390, respectively, have one or more external connectors 450, such as, for example threading, ribs, nibs, or any other type of surface feature, an example of which is shown in FIGS. 15A and 15B. In a further embodiment, there is a side slit 455 within the arms that communicates the interior duct with the exterior of the arm, which is shown, by way of example, in FIG. 15A. The side slit can be any length, but will, preferably extend along most or the entire length of the duct. The side slit 455 allows the proximal spine end 505 or distal spine end 515 to slide sideways into the duct of their respective ball joint.

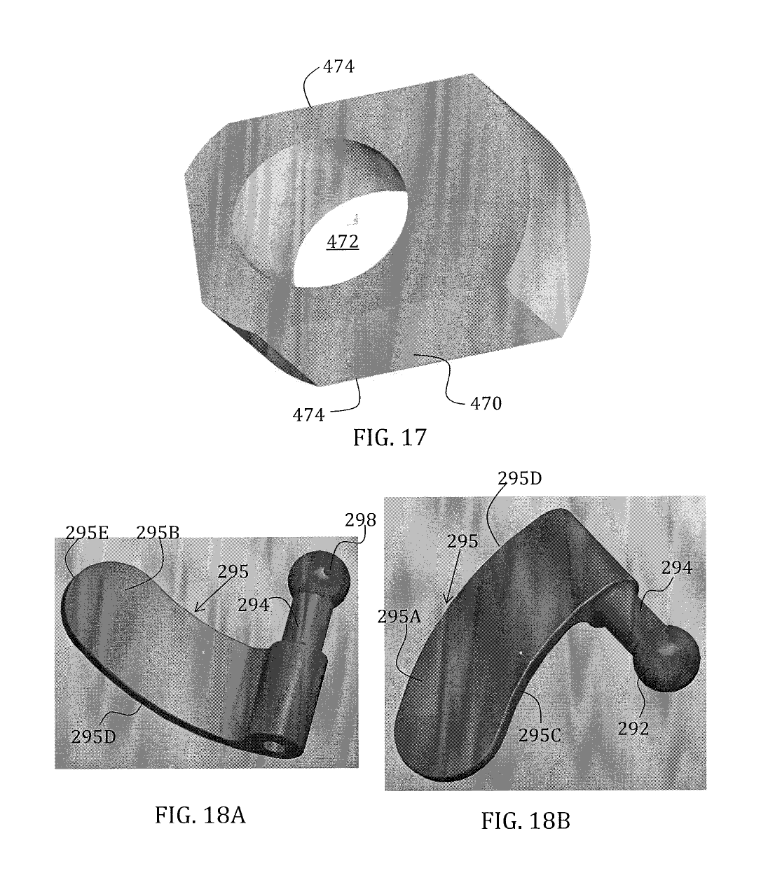

To secure the spine within the ducts, the spine ends can be made or configured with a tippet 530, an example of which is shown in FIG. 14C. A tippet can be located at or near the proximal and/or distal ends of the spine and can be wider or have an otherwise larger diameter than the spine. FIG. 14C illustrates a non-limiting example of a spine 520 with a tippet at the proximal tip and distal tip. Alternatively, a tippet piece 470 can be attached at or about the ends of the spine. A tippet piece 470 can have a hole 472 therein or there through into which the spine end can fit and be secured by any method or technique known to those with skill in the art. The tippet piece can act to widen or otherwise increase the diameter of the spine, similarly to a spine configured with a tippet would. FIG. 17 illustrates on example of a tippet piece 470.

In a further embodiment, the ducts 296 and 396 within the arms have a tippet slot 460. A tippet slot can be located anywhere along the length of a duct and in a specific embodiment is at the bottom of the duct, nearest their respective hubs. The tippet slot can be contiguous with the side slit 455. The tippet slot 460 can further have a larger diameter than the rest of the duct and can further have a shape and or dimensions that accommodate the shape and/or dimensions of the tippet 530. In a specific embodiment, the tippet or tippet piece have a distinctive shape or configuration, such that they can be fit into the tippet slot in only one direction. In other words, the tippet or tippet piece can “dovetail” with the tippet slot. This can ensure that a blade is properly aligned within the ball joint. Otherwise, when the hubs are brought together, as described above, the blades will not properly overlap or align to form the 3-dimensional shape. FIG. 17 illustrates one example of a tippet piece that has a distinct curvilinear shape and a hole 472 that is offset from the center. With this embodiment, the spine end can be inserted into the hole 472 with the wing 580 aligned parallel with the linear edges 474 of the tippet piece.

To attach a spine to the ball joint, the spine end can be pushed or slid through the side slit 455 with the tippet 530 or attached tippet piece 470 properly aligned to be received by the complimentarily shaped tippet slot 460. Once inserted the tippet or tippet piece inhibits the spine from sliding out of the end of the duct. However, to inhibit the spine end from sliding back through the tippet slot, the tippet or tippet piece can be secured within the duct, such as, for example, by friction fit, adhesive products, a snap fit, or other methods or techniques known to those with skill in the art.

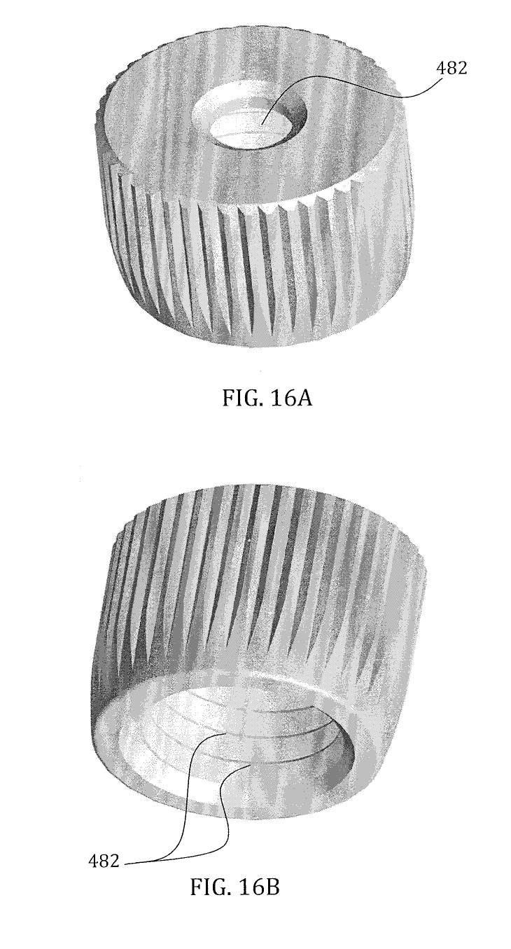

In one embodiment, a slit cover 480 can be fit over an arm. A slit cover can have an internal connector 482 that be cooperatively engaged with the external connector 450 on the ball joint arms, so as to cover, at least partially, the side slit 455. In a further embodiment, a slit cover has a spine hole 482 through which the spine of the blade can protrude, such that the tippet or tippet piece is within the slit cover. In one embodiment, the tippet or tippet piece can be formed on or attached to the spine end after the cover is slid over the spine. Alternatively, the tippet or tippet piece can be configured to push through the spine hole, perhaps in one direction only, after being formed or attached to the spine end. FIGS. 16A and 16B illustrate an example of a slit cover. FIG. 16A shows an embodiment of a spine hole 482 in a slit cover and FIG. 16B illustrates a specific example of a slit cover with internal threading that can be connected to the external threading on a ball joint. The use of slit cover can inhibit the spine and tippet or tippet piece from exiting the side slot.

As mentioned above, a fan assembly of the subject invention can be particularly amenable for use outdoors. However, it can be beneficial to provide some additional support to the blade, particularly the exposed outside edge 570, to prevent fraying, tearing or other types of damage. In one embodiment, a blade assembly includes a wing support 590 that at least partially covers the outside edge of a blade. FIGS. 1A and 14A illustrate examples of this embodiment. In one embodiment, the wing support extends from the spine and couples with the outside edge. The wing support can extend from the proximal end 5 or the distal end 15 of the spine and extend along a portion of the blade. In a specific embodiment, shown, for example, in FIG. 14A, the wing support extends from both a proximal and distal location on the spine and extends to cover the entire outside edge of a wing. Ideally, the shape of the wing support is compatible with the shape of the wing, such that it couples with the entire outside edge. The wing support can also have any of a variety of additional features or extensions therefrom that can contribute to the overall shape of the fan assembly. Thus, the dimensions of a wing support can vary. FIG. 14B illustrates an embodiment of a wing support having dimensions similar to those of the spine from which it extends. However, the wing support can have a different shape than the spine.

With regard to the material of a blade and/or wing, the expected use of the fan assembly, whether indoors or outdoors, can factor into the selection of materials. Further, the selection of materials can depend upon whether a wing support will be used, and whether the blade will be part of the spine or removable, as discussed above. The embodiments of the subject invention are particularly advantageous for outdoor use, so it can be helpful for the blade materials to be at least weather resistant. Further, as mentioned above, the blade can be used in a vertical fashion, where the spine and the blade are substantially parallel to the central stem. In an alternative embodiment, the spine and blade are bent to a particular form to provide the fan assembly with a specific 3-dimensional shape. Thus, the material of the blade and/or blade assembly can depend upon the configuration of the blade assembly relative to the central stem. In one embodiment, the material of a blade is semi-rigid and capable of self-support with or without the use of a wing support. In one example, the blade and/or blade assembly can be plastic, nylon, metal, rubber, wood or wood products, or combinations thereof.

The embodiments of the subject invention provide a fan assembly that can be used under different indoor and outdoor environmental conditions. One or more blades can be attached to an upper bearing assembly and a lower bearing assembly around a central stem. The shape and configuration of the blades can further impart the fan assembly with a 3-dimensional appearance that responds to wind or other air flow, causing a spinning effect. The rigidity of the central stem, as well as components of the blade, ensure that the fan assembly maintains the 3-dimensional shape even under high wind or air flow conditions.

The scope of the invention is not limited by the specific examples and suggested procedures and uses related herein since modifications can be made within such scope from the information provided by this specification to those skilled in the art. Thus, the examples and embodiments described herein are for illustrative purposes only and various modifications or changes in light thereof will be suggested to persons skilled in the art and are to be included within the spirit and purview of this application.

Any reference in this specification to “one embodiment,” “an embodiment,” “example embodiment,” “further embodiment,” “alternative embodiment,” etc., is for literary convenience. The implication is that any particular feature, structure, or characteristic described in connection with such an embodiment is included in at least one embodiment of the invention. The appearance of such phrases in various places in the specification does not necessarily refer to the same embodiment. Further, when a particular feature, structure, or characteristic is described in connection with any embodiment, it is within the purview of one skilled in the art to affect such feature, structure, or characteristic in connection with other ones of the embodiments.

The invention has been described herein in considerable detail, in order to comply with the Patent Statutes and to provide those skilled in the art with information needed to apply the novel principles, and to construct and use such specialized components as are required. However, the invention can be carried out by specifically different equipment and devices, and various modifications, both as to equipment details and operating procedures can be effected without departing from the scope of the invention itself. Further, although the present invention has been described with reference to specific details of certain embodiments thereof and by examples disclosed herein, it is not intended that such details should be regarded as limitations upon the scope of the invention except as and to the extent that they are included in the accompanying claims.

I claim:

1. A fan assembly comprising:
a central stem comprising
a shaft assembly with a proximal end and a distal end,
an upper bearing assembly operably connected to the shaft assembly, and
a lower bearing assembly operably connected to the shaft assembly and proximal to the upper bearing assembly;
at least one blade assembly comprising
a spine with a proximal tip operably connected to the lower bearing assembly and a distal tip operably connected to the upper bearing assembly,
a wing having an inside edge and an outside edge, where the inside edge is operably connected to the spine,
a wing support covering at least a portion of the outside edge of the wing, such that the at least one blade spins around the shaft assembly.

2. A fan assembly according to claim 1, further comprising a top hub for securing the upper bearing assembly to the shaft assembly.

3. A fan assembly according to claim 2, further comprising at least one securing mechanism for maintaining the position of the lower bearing assembly on the shaft assembly.

4. A fan assembly according to claim 3, wherein the shaft assembly comprises,
an internal shaft,
an external slide sleeve with a channel for receiving the proximal end of the internal shaft, and at least one shoulder near the distal end for supporting the upper bearing assembly.

5. A fan assembly according to claim 3, wherein a securing mechanism is a clip.

6. A fan assembly according to claim 4, further comprising,
at least one twist ball joint comprising a sphere and an arm attached thereto, and
at least one socket within the upper bearing assembly that allows the twist ball joint to rotate and translate, the socket comprising,
a spherical void, for receiving the sphere, that allows the twist ball joint to rotate within the upper bearing assembly,
a trench, for receiving the arm, that is contiguous with the spherical void, and
a proximal translation slot contiguous with the trench that allows the arm to translate within the socket,
wherein the twist ball joint further couples the distal tip of the spine to the socket.

7. A fan assembly according to claim 6, further comprising at least one bearing within the upper bearing assembly.

8. A fan assembly according to claim 7, further comprising a distal edge on the trench that limits the translation of the twist ball joint.

9. A fan assembly according to claim 8, wherein translation of the twist ball joint is limited to between 0° and 84° in a proximal direction.

10. A fan assembly according to claim 9, further comprising,
at least one ball joint comprising a sphere and an arm attached thereto, and
at least one socket within the lower bearing assembly that allows the ball joint to rotate and translate, the socket comprising,
a spherical void, for receiving the sphere, that allows the ball joint to rotate within the upper bearing assembly,
a trench, for receiving the arm, that is contiguous with the spherical void, and
a distal translation slot contiguous with the trench that allows the arm to translate within the socket,
wherein the ball joint further couples the proximal tip of the spine to the socket.

11. A fan assembly according to claim 10, further comprising at least one bearing within the lower bearing assembly.

12. A fan assembly according to claim 11, further comprising a distal edge on the lower bearing assembly that limits the translation of the ball joint.

13. A fan assembly according to claim 12, wherein translation of the ball joint is limited to between 0° and 50° in a distal direction.

14. A fan assembly according to claim 13, further comprising a lower slide sleeve around the internal shaft and operably connected to the proximal end of the external slide sleeve.

15. A fan assembly according to claim 14, further comprising,
at least one nub on the twist ball joint,
a longitudinal furrow within the at least one socket of an upper bearing assembly, and
a latitudinal furrow within the at least one socket of an upper bearing assembly and contiguous with the longitudinal furrow,
such that the nub can be operably engaged with the longitudinal furrow and the latitudinal furrow to control rotation and translation of the twist ball joint.

16. A fan assembly according to claim 15, further comprising a wing support on the blade assembly.

17. A fan assembly according to claim 15, wherein rotation of the twist ball joint within the socket causes the one or more blades to turn perpendicular to the central shaft and overlap with each other.

18. A fan assembly according to claim 10, further comprising at least one external connector on the arm of a twist ball joint or a ball joint.

19. A fan assembly according to claim 18, further comprising a side slit in the arm through which the spine is operably connected to the arm.

20. A fan assembly according to claim 18, further comprising a slit cover that operably connects to the external connector.
